(19) United States
(12) Patent Application Publication
(10) Pub. No.: US 2009/0293761 A1
(43) Pub. Date: Dec. 3, 2009

(54) Composition for wood treatment comprising an injectable aqueous wood preservative slurry having sparingly-soluble biocidal particles and pigments

(76) Inventors: H. Wayne Richardson, Sumter, SC (US); Robert L. Hodge, Sumter, SC (US); Dwight W. Glover, Ridgefield Park, NJ (US); Michael P. Pompeo, Sumter, SC (US); Christopher G. Hayden, Alexandria, VA (US)

Correspondence Address: MORGAN LEWIS & BOCKIUS LLP, 1111 PENNSYLVANIA AVENUE NW, WASHINGTON, DC, 20004, US

(21) Appl. No.: 11/596,874

(22) PCT Filed: May 17, 2005
(86) PCT No.: PCT/US05/17008

§ 371 Date: May 7, 2009

Related U.S. Application Data
(60) Provisional application No. 60/571,535, filed on May 17, 2004.

(30) Foreign Application Priority Data
May 17, 2004 (US) 10868967
Oct. 12, 2004 (US) 10961143
Oct. 12, 2004 (US) 10961155
Oct. 12, 2004 (US) 10961206
Dec. 13, 2004 (US) 11009042

(51) Int. Cl. C09D 5/14

(52) U.S. Cl. 106/18; 106/18.36; 106/15.05; 106/18.32; 106/18.33; 106/18.29

(57) ABSTRACT

An aqueous wood-injectable particular-based wood preservative comprising: 1) dispersants in an amount sufficient to maintain biocidal particles in a stable slurry; 2) injectable sub-micron biocidal particles comprising a solid phase of at least one of a sparingly soluble organic biocide, a sparingly soluble copper salt, copper(I)oxide, a sparingly soluble zinc salt, zinc oxide; a sparingly soluble nickel salt; and a sparingly soluble tin salt, wherein less than 2% by weight of the biocidal particles have an average diameter greater than 1 micron, and at least 20% by weight of the biocidal particles have an average diameter greater than 0.08 microns; and 3) at least one pigment particle or dye in an amount sufficient to impart a discernable color or hue to the wood, when compared to wood treated with the same particulate system but without the pigment.

### CROSS-REFERENCE TO RELATED APPLICATIONS

This application claims priority to pending U.S. Provisional Application No. 60/571,535 filed May 17, 2004, and to co-pending U.S. patent application Ser. Nos. 10/868,967 filed Jun. 17, 2004; 10/961,155 filed Oct. 12, 2004; 10/961,206 filed Oct. 12, 2004; 10/961,143 filed Oct. 12, 2004; and 11/009,042 filed Dec. 13, 2004, the disclosures of which are incorporated herein by reference thereto.

### STATEMENT REGARDING FEDERALLY SPONSORED RESEARCH OR DEVELOPMENT

N/A.

### INCORPORATION-BY-REFERENCE OF MATERIAL SUBMITTED ON A COMPACT DISC

N/A.

### SEQUENCE LISTING

N/A.

### FIELD OF THE INVENTION

The present invention relates to wood preservatives, particularly wood preservatives comprising 1) biocidal particles, such as particles containing a solid phase of slightly-soluble (in water) salts such as copper salts, nickel salts, tin salts, and/or zinc salts, and/or particles containing a solid phase of substantially-insoluble (in water) organic biocides such as tebuconazole and/or chlorothalonil, or any mixtures thereof; and at least one pigment, wherein the pigment comprises particles and/or slightly-soluble (in water) organic pigments in an amount sufficient to impart a discernable color to the wood when injected in into the wood in a wood-preserving amount, as well as methods to prepare the wood preservative, and wood preserved using the wood preservatives.

### BACKGROUND OF THE INVENTION

Preservatives are used to treat wood to resist insect attack and decay. However, wood treated with such preservatives often has undesirable color and/or appearance and is prone to weathering to a gray colored material. The commercially used preservatives are separated into the following three basic categories, based primarily on the mode of application: waterborne, creosote, and oil borne preservatives. In each case, the active components of the wood preservative are in a solution, although the solution may comprise an emulsion of the organic biocide in oil and/or surfactants and a water carrier.

Creosote and oilborne preservatives are made of certain oily compounds, typically dissolved in a solvent or light oil, including pentachlorophenol (commonly known as “penta”), copper naphthenate, and copper-8-quinolinolate. Modern organic biocides, especially azoles such as tebuconazole are quite soluble in common organic solvents, while others such as chlorothalonil possess only low solubility.

Commercially available waterborne preservatives include chromated copper arsenate (CCA), alkanolamine copper with an organic biocide, and ammoniacal copper with an organic biocide. All of these soluble copper-containing wood preservatives require a minor amount of a second organic biocide that is efficacious against one or more certain copper resistant pests, particularly molds. The second biocide is often slightly water soluble or be emulsified, and may be composed of a triazole group or a quaternary amine group or a nitroso-amine group. Organic biocides with good solubility can be dissolved at high concentrations in a small amount of organic solvents/light oils, and that solution can be dispersed in water with appropriate emulsifiers to produce an injectable aqueous emulsion which is mixable with the waterborne copper-containing biocides. Organic biocides which possess low solubility in organic solvents/light oils can be incorporated into a material containing a substantial excess of surfactant sufficient to solvate or form an homogenous mixture with the organic biocide, and this resulting material can then be emulsified with water.

The principal criteria for commercial acceptance, assuming treatment efficacy, is cost. However, a variety of other factors affect the utility of preserved wood, including color and appearance, longevity, and environmental affects.

The greatest drawback to the amine/copper-containing wood preservatives is that they are many times more leachable, compared to CCA, creosote, and oilborne preservatives. This leaching is of concern for at least two reasons: 1) removal of the copper portion of the pesticide from the wood by leaching will compromise the long term efficacy of the formulation, and 2) the leached copper causes concern that the environment will be contaminated. Copper leaching is such a problem that some states do not allow use of wood treated with the amine/copper containing wood preservatives near waterways.

The other factor having a large impact on the use of wood treated by the various methods is the color and appearance of the wood. Creosote and oilborne preservatives leave a wood surface that often is non-paintable, dark, and unnaturally colored, and can be irritating to skin. Wood treated with the soluble amine/copper formulations turn green or grey-green because the copper deposited in the wood is weathered, be it by reacting with moisture, air, and one or more components of the wood, or by reacting with the sun's ultraviolet rays, or both. Further, the industry has had difficulties coloring the copper/amine treated wood, compared to the relative ease of coloring CCA treated wood. U.S. Pat. No. 4,752,297 describes a process of coloring wood with an iron salt, where a environmentally resistant colorant in wood is made by contacting the wood with aqueous iron salts of organic (carboxylic) acids. This patent also describes the benefits of having one or more preservative metals—copper, chromium, arsenic and zinc—in addition to the iron carboxylate material. A preferred colorant is ferric ammonium citrate. The colorants impart a brown color and prevent the wood from aging to a gray or green color.

A preferred pigment is iron oxides and/or hydroxides. U.S. Pat. No. 4,539,047 describes painting wood to maintain a fresh appearance, with its paint comprising mineral spirits, unsaturated resin, wax, and a transparent ultraviolet-absorbing pigment, preferably where said pigment is a hydrated iron oxide pigment. Various methods of producing UV blocking iron oxide pigments are described in U.S. Pat. No. 2,558,304, the disclosure of which is incorporated by reference. U.S. Pat. No. 4,702,776 describes a method of manufacturing pigmentary iron oxide particulates.

It is known that pigments, many of which are in particle form, can be injected into wood. It is also known that emulsions can be injected into wood. For example, it is known in the art that insoluble organic biocides can be milled with surfactants and dispersants to form a material that appears fluid and is dispersible as an emulsion into water, wherein the emulsion is then used to pressure treat wood. Preservative compositions, such as those disclosed in U.S. Pat. No. 5,098,472, contain: (a) an emulsion of a wood preservative grade creosote; (b) 5-95% water; (c) one or more pre-dispersed micronized pigments; (d) a rheology structuring agent present in an amount of 2.5 weight percent or less; (e) 0.25 to 10 weight percent of a soap which is an alkali metal salt of a wood derived resin acid; (f) 0.1 to 5 weight percent of a surfactant; (g) 0.25 to 2 weight percent of a natural or synthetic pigment modifying resins or anti-settle additive; and (h) 0.25 to 5 weight percent of a lignin sulfonate. The emulsion can be produced under conditions of ultra-high sheer. In one embodiment, the natural or synthetic pigment modifying resins or anti-settle additives can be selected from the group consisting of gum copol, gum rosin, vatica resins, shellac, wood rosin, tall oil rosin, chinese wood oil, high molecular weight primary amines derived from pine resin acids, casein, aliphatic resins, aromatic resins, coumarone-indene, terpene resins, polyterpene resins, terpene phenol, alkyd resins, rhodenes, polyurethane resins, silicone resins and unmodified hydrogenated castor oil, or the like, or a combination thereof. Even with current aqueous copper-amine-based preservative systems, emulsions are sometimes added, for example an emulsion of “solubilized tebuconazole admixed with the dilute aqueous copper amine fluid and injected into wood. To solubilize an azole such as tebuconazole, large amounts of dispersants are needed, e.g., between 6 and 15 parts dispersant per one part (by weight) of tebuconazole forms an emulsifiable material.

Recently there has been a number of disclosures relating to a new class of wood preservative using particles containing biocidal material, where the particles are of a size that is injectable into wood. Some embodiments of these disclosures address issues of leaching, but generally do not address the issue of color. One objective of this disclosure is to disclose effective methods of altering the appearance of wood treated with these particulate biocides, which can involve staining the wood, staining the particulates, or both. More particularly, this disclosure relates to effective methods of altering the appearance of wood treated with particulate biocides which are not primarily polymer, such as those describes in numbers 3 below. Exemplary disclosures which describe the use of particulate biocides includes the following:

1) U.S. Pat. No. 6,306,202 which suggests that particles containing copper salts or oxides can be injected into wood. The disclosure is unclear, as the title states the composition, which comprises more than 96% water, and less than 4% of the product of milling between 0.01 and 0.2 parts of copper salts with 1 part borax and between 1 and 2 parts water. The text states “small amounts of water insoluble fixed copper compounds are not objectionable in solid wood preservatives so long as their particle size is small enough to penetrate the wood,” and suggests “so long as copper compound particles do not settle from the dilution in one hour, the composition is suitable for pressure treating . . . of solid wood.”

1) A variety of patents describe use of polymeric particles in wood preservative systems having iocidal substances. U.S. Pat. No. 5,196,407 which describes a wood preservative composition comprising an organic fungicide such as a triazole or carbamate, a diluent (light oil or solvent), and optionally an emulsifier, a wetting agent, or an organic-chemical binder. The binder is preferably a resin based on methylacrylate/n-butyl acrylate copolymer, a styrene/acrylic ester copolymer, or a polyvinyl versatate, finely dispersed in the water, and having a particle size less than 0.07 microns. Such a binder would bind to the organic biocide such as the triazole, and its action is “preventing the biocidal active substances from remigrating from the wood to the wood surface. Exemplary examples had 19% alkyd resin/1.5% tebuconazole, 19% alkyd resin/0.8% tebuconazole, 8% solid styrene/acrylic ester copolymer/1.5% tebuconazole, or 4% solid methylacrylate/n-butyl acrylate copolymer/0.8% tebuconazole. See also Reissue Pat. 31,576 which describes incorporating such resins in an amine/copper wood preservative, where the emulsions have “a fine particle size as are described in West German patent specification No. 2,531,895”, wherein the composition can be pressure impregnated into wood. Another method of forming such microparticles is described in U.S. Pat. No. 4,923,894, which describes a process of polymerizing ethylenically unsaturated monomers in the presence of the bioactive substance. The preferred diameter of the microparticles is 0.01 to 2 microns. Various comonomers described as useful in forming the microparticles include acrylates. Various biocides include thiazoles, quaternary ammonium compounds, halogenated phenols, and specific wood preservative biocides including organotin, copper hydroxyquinolinate, and so forth, where “the polymeric microparticles of this invention may carry these wood preservatives.” The preservatives in the examples were merely painted on the wood. U.S. Pat. No. 4,737,491 describes a process where copper and/or zinc salts are complexed with polymers, and the polymers (which are either soluble or which form micelles in the water) are completely injected into wood provided the molecular weight of the polymers is below about 2000, but at higher molecular weights only a portion of the polymer is injected into wood.

2) Published United States Patent Application 20040258767 to Leach and Zhang, the disclosure of which is incorporated herein by reference thereto, describes injecting into wood particles of a wood preservative composition comprising: (a) an inorganic component selected from the group consisting of a metal, metal compound and combinations thereof, wherein the metal is selected from wherein the inorganic component is selected from the group consisting of copper, cobalt, cadmium, nickel, tin, silver, and zinc; and (b) one or more organic biocides, wherein at least the inorganic component or the organic biocide is present as micronized particles of size 0.005 microns to 25 microns. Preferred inorganic compounds are copper hydroxide, copper oxide copper carbonate, basic copper carbonate, copper oxychloride, copper 8-hydroxyquinolate, copper dimethyldithiocarbamate, copper omadine and copper borate.

3) Co-owned published United States Patent Application 20040258768 to Richardson and Hodge, the disclosure of which is incorporated herein by reference thereto, and to which this application claims priority, describes injecting into wood a wood preservative composition comprising: particles of one or more substantially crystalline copper salt sparingly soluble copper salts, tin salts, and/or zinc salts, wherein the salts make up 20% or more of the particle weight, wherein greater than 98% by weight of the particulates have a diameter less than 0.5 microns, preferably less than 0.3 microns, as determined by the settling velocity of the particle in water, and at least 50% have a diameter greater than 40 nanometers. Exemplary particles contain for example copper hydroxide, basic copper carbonate, copper carbonate, basic copper sulfates including particularly tribasic copper sulfate, basic copper nitrates, copper oxychlorides, copper borates, basic copper borates, and mixtures thereof. The particles typically have a size distribution in which at least 50% of particles have a diameter smaller than 0.25 microns, 0.2 microns, or 0.15 microns. This disclosure emphasizes the importance of minimizing or eliminating all particles having a size greater than 1.5 microns, or even 1 micron, and the importance of having a substantial portion, even as much as 89% by weight of all the salts, be in particles with a diameter greater than 0.01 microns. The disclosure also describes minimizing amines, the importance of adding stabilizing amounts of zinc and magnesium to copper hydroxide, the possibility of also including in the preservative slurry injectable metallic copper and/or zinc, the benefits of limiting the amount of polymer associated with the particles, and the benefits of having a portion of the supplemental organic biocide be coated as a layer on the sparingly soluble salt-containing particles. Further, this disclosure states large particulates or large agglomerations of particulates impose a visible and undesired bluish or greenish color to the treated wood. Individual particles of diameter less than about 0.5 microns that are widely dispersed in a matrix do not color a wood product to the extent the same mass of particles would if the particle size exceeded 1 micron.

4) United States Patent Application 20030077219 to Ploss et al., the disclosure of which is incorporated herein by reference thereto, describes a method for producing copper salts from at least one cupriferous and one additional reactant, where micro-emulsions are prepared from two reactants while employing at least one block polymer to obtain intermediate products with a particle size of less than 50 nm, preferably 5 to 20 nm. The application teaches wood treatment applications, stating the copper compounds produced pursuant to the described method can easily and deeply penetrate into the wood due to their quasi atomic size, which they suggest can eliminate or reduce the need for pressure impregnation. Agglomerates of a multitude of primary particles having a size range of 5 to 20 nm can form, where the agglomerates have at least one dimension that is about 200 nanometers. The application suggests doping about 5 wt % zinc into a copper salt composition intended for agricultural applications to provide enhanced surface adhesion. Example particle sizes was between 10 and 50 nm and agglomerate sizes between 100 and 300 nm. During the immersion of equivalent wood into a copper hydroxide micro-emulsion prepared pursuant to the method, the copper hydroxide was not limited to the surface, but instead penetrated to a depth of “more than 10 298 mm.”

5) U.S. Pat. No. 6,521,288 to Laks et al, the disclosure of which is incorporated herein by reference thereto, describes adding certain biocides to polymeric nanoparticles, and claims benefits including: 1) protecting the biocides during processing, 2) having an ability to incorporate water-insoluble biocides, 3) achieving a more even distribution of the biocide than the prior art method of incorporating small particles of the biocide into the wood, since the polymer component acts as a diluent, 4) reducing leaching with nanoparticles, and 5) protecting the biocide within the polymer from environmental degradation. The application states that the method is useful for biocides including chlorinated hydrocarbons, organometallics, halogen-releasing compounds, metallic salts, organic sulfur compounds, and phenolics, and preferred embodiments include copper naphthenate, zinc naphthenate, quaternary ammonium salts, pentachlorophenol, tebuconazole, chlorothalonil, chlorpyrifos, isothiazolones, propiconazole, other triazoles, pyrethroids, and other insecticides, imidichloprid, oxine copper and the like, and also nanoparticles with variable release rates that incorporate inorganic preservatives as boric acid, sodium borate salts, zinc borate, copper salts and zinc salts. The only examples used the organic biocides tebuconazole and chlorothalonil incorporated in polymeric nanoparticles. describes incorporating biocides into polymeric nanoparticle. Claims particles useful for inorganic preservatives as boric acid, sodium borate salts, zinc borate, copper salts and zinc salts. The polymers include polycarboxylic acids which can dissolve and chelate copper salts, including “insoluble” copper salts such as copper hydroxide. See, for example, the disclosure of U.S. Pat. No. 6,471,976 which teaches dissolving insoluble copper salts with polycarboxylic acids to make a biocidal polymeric material.

What is needed in the art is colorants and UV protection for this new class of particle-based wood preservatives, these preservatives comprising injectable particulates of sparingly soluble copper-containing materials, sparingly soluble nickel-containing materials, sparingly soluble tin-containing materials, sparingly soluble zinc-containing materials, or some combination thereof.

### SUMMARY OF THE INVENTION

The principal aspect of the invention is the manufacture and use of a wood-injectable particulate-based wood preservative comprising: 1) water as a carrier; 2) injectable biocidal particulates comprising a solid phase of at least one of a sparingly soluble organic biocide, a sparingly soluble copper salt, copper(I)oxide, a sparingly soluble zinc salt, zinc oxide; and a sparingly soluble tin salt; 3) one or more dispersants, and 4) at least one pigment in an amount sufficient to impart a discernable color or hue to the wood, when compared to wood treated with the same particulate system but without the pigment. The pigment is added primarily as a pigment and optionally as a UV blocker. The term pigment also encompasses dyes. The pigments can be injectable particulates, oil-soluble organic pigments, water-soluble pigments, or combinations thereof, but the preferred pigments are injectable particulates and/or oil-soluble organic pigments. The most preferred pigments are small particles comprising a solid phase of inorganic salt precipitates and metal oxides. The invention also encompasses wood treated with the pigmented wood preservative system.

The preferred embodiment of the invention is the manufacture and use of a wood-injectable particulate-based wood preservative comprising:

1) water as a carrier,

2) injectable biocidal particulates comprising a solid phase of at least one of a sparingly soluble organic biocide, a sparingly soluble copper salt, copper(I)oxide, a sparingly soluble zinc salt, zinc oxide; and a sparingly soluble tin salt,
wherein at least 20%, preferably at least 40%, more preferably at least 60% by weight of the injectable biocidal particulates have an average diameter greater than 0.04 microns, preferably greater than 0.06 microns, for example greater than 0.08 microns, and
wherein at least 96%, preferably at least 98%, more preferably at least 99%, and most preferably 100% by weight of the injectable biocidal particulates have an average diameter less than 1 micron, preferably less than 0.7 microns, for example less than 0.4 microns;

3) one or more dispersants, and

4) at least one pigment, at least one dye, or both, in an amount sufficient to impart a discernable color or hue to the wood, when compared to wood treated with the same particulate system but without the pigment and/or dye. As used herein, the terms “particulate” and “particle” are used interchangably. As used herein the term “pigment” means a particle which comprises a solid phase of the coloring agent, that when used in sufficient concentration imparts a desired color or hue to the wood. As used herein the term “dye” means an organic or metallo-organic compound that imparts color, and that typically is not used as a solid phase but rather as dispersed molecules or as coatings, when used in sufficient concentration imparts a desired color or hue to the wood. Generally, but not always, pigments comprise a metal ion. If the pigment comprises metal ions, and if the biocidal particulates also comprise a solid phase of a metal oxide, hydroxide, and/or sparingly soluble salt, then the metal ion in the pigment must be different than the metal ion in at least some biocidal particles. For example, if the biocidal particles include a solid phase of a sparingly soluble copper salt such as copper hydroxide or copper carbonate (that is, a salt where more than one half the moles of cations are copper), then the pigment can comprise for example metal oxides where the metal most abundant in the pigment (by moles metal per mole pigment) is not copper. Also for example, if a metal is a minor component of the total cations in the biocidal particle, for example the magnesium metal in a copper hydroxide having up to 20% of the copper replaced with magnesium, then the pigments can comprise inorganic magnesium salts or oxides, but not inorganic copper salts or oxides.

It is possible to impart some dye to prior-art aqueous copper-amine-based preservative systems, for example by using a water-soluble dye or an alcohol-soluble dye added to the water-amine carrier. Even oil-soluble dyes can be added to such a system, if for example an emulsion is formed using significant quantities of dispersants. There are a number of organic biocides which are efficacious in wood but have very limited solubility in water and in alcohol. The most useful of these is chlorothalonil and a number of azoles, such as tebuconazole (TEB). We call such organic biocides “sparingly soluble.” It is known in the art to add an emulsion of “solubilized” azole, such as TEB, to a dilute aqueous copper amine fluid, which is subsequently injected into wood. To solubilize an azole such as tebuconazole, large amounts of dispersants are needed, e.g., between 6 and 15 parts dispersant per one part (by weight) of TEB forms an emulsifiable material. Oil-soluble dyes can be added into such an emulsion, though if an appreciable amount of oil-soluble dyes are added then more dispersant would be required. Unfortunately, the quantity of emulsified azole is very low, e.g., under 0.1% of the weight of the treatment, and to disguise or mask a color such as the green-gray that results from soluble copper treatments, generally dying or pigmenting much of the wood surfaces is required. So while it is possible to dye soluble copper wood treatments by adding an organic dye, this emulsion will provide insignificant coverage of the green-gray tint caused by aging of the soluble copper disposed on the wood substrate. Additionally, the dye must usually be darker than the green-gray material it is attempting to cover.

In contrast, it is easy to disguise and mask the color imparted by a particulate biocide used in wood. A preferred method of this invention is to partially, substantially, or completely coat the external surface of the biocidal particles with an appropriate pigment and/or dye. Since the particulate biocide is in the form of concentrated (solid phase) sub-micron particles that advantageously do not form aggregations, the particles will impart less color than would a similar amount of biocide coated as a layer on the wood. Further, since the biocidal particulates have only a very small surface area, relative to the surface area of the wood in which the particles reside, relatively little dye and/or pigment is needed to disguise or mask the color imparted by particle-based wood preservative systems if a large portion of the dye and/or pigment is disposed on the surface of the biocidal particulates. Furthermore, the dye and/or pigment disposed around a biocidal particle can help maintain the stability of the underlying solid biocidal material by for example partially shielding the solid biocidal material from contact with ultraviolet radiation, water, and acids.

Generally, the size, amount, and dispersion of biocidal particles having pigment and/or dye associated on the surface thereof is small, and it is therefore easier to disguise or mask the color of the biocidal particulates than it is to impart a particular color throughout the wood. However, with the current system of utilizing particulate biocidal materials in conjunction with one or more particulate pigments and/or oil-soluble pigments associated on the surface thereof that effectively mask the particulates, and optionally that can further contribute color, it is possible to additionally dye the wood with a dispersed dye or pigment, for example a water-soluble pigment, where the color can be light colors or dark colors. Recall that when a soluble copper wood preservative system such as one or more of the copper/amine wood preservative systems, any colorants must dye the wood a darker color than the green-gray that results from the copper aging/oxidation of the wood. When a particle-based wood preservative system is used, coating biocidal particles with a light neutral color or even white will readily mask any residual color imparted by the biocidal particle itself, and, if desired, additional dye or pigment can be added to color the wood without regard to the color (or eventual color) the underlying biocidal particulates may be. The color of the pigment or dye disposed on the surface of biocidal particles can be the same or can complement the color the wood is intended to be dyed to, or alternatively the pigment disposed on the biocidal particles can simply be used to conceal the biocidal particles by for example coating the biocidal particles to lighten, darken, or put a neutral color about the biocidal particles.

Wet ball milling (or an equivalent milling process) of biocidal particles is important, both to remove by attrition particles having a size over 1 micron, but also to promote adherence of the dispersants, dyes, adjuvants, an/or pigments to the surface of the biocidal particles. Said biocidal particulates are advantageously wet milled in a mall mill having milling media (beads) which preferably comprise a zirconium compound such as zirconium silicate or more preferably zirconium oxide. Other milling media, including steel and various metal carbides, can often be used, provided the density of the milling media is greater than 3 g/cc (some biocides such as chlorothalonil are difficult to mill and require milling beads having a density greater than about 5 g/cc, which can be obtained by using for example zirconia beads or doper zirconia beads). A more important criteria for the milling media is that it have at least 25% by weight, preferably at least 50% or 100%, of the individual milling beads having an average diameter of between 0.3 and 0.8 mm, preferably between about 0.4 and about 0.7 mm.

One preferred embodiment of the invention comprises one or more organic dyes which at least partially coat the exterior of the biocidal particulates in the slurry. The dye or dyes are advantageously added to the wood preservative composition prior to wet milling the biocidal particles with sub-millimeter zirconium-containing milling media. Inclusion of the dyes and dispersants into the milling process, as opposed to the addition of the dyes after completion of the milling, is expected to provide a more stable colored composition. The colored compositions of the present invention can exhibit good stability, and can be utilized to penetrate various substrates, such as wood, and to impart desirable color characteristics to the treated substrates. Said organic dyes are beneficially oil soluble, and are added along with appropriate surfactants/dispersants to the liquid portion of the milling media prior to wet milling the biocidal particles. Wet milling with the above milling media is believed to promote adherence of dispersants to the biocidal particulates. Advantageously the total weight of surfactants and/or dispersants in the milling medium is such that less than 1.5 parts (by weight), preferably less than 1 part, for example between about 0.05 parts to about 0.5 parts of total surfactant and dispersant adhere to 1 part (by weight) of biocidal particles. Advantageously the total weight of oil-organic dyes in the milling medium is such that less than 1.5 parts (by weight), preferably less than 1 part, for example between about 0.05 parts to about 0.5 parts of total surfactant and dispersant adhere to 1 part (by weight) of biocidal particles.

Another preferred embodiment comprises one or more particulate pigments which adhere to the exterior of the biocidal particulates in the slurry. Larger copper-containing biocidal particles having very finely divided particulate iron oxide pigments, zinc oxide pigments, magnesium oxide pigments, and/or tin oxide pigments which at least in part adhere to larger (but still injectable into wood matrices) copper-containing biocidal particles will disguise, mute, or totally conceal the color or the copper particulate. In one preferred embodiment the pigment particles are smaller than at least some of the biocidal particles, e.g., the d₉₈ and the d₅₀ of the biocidal particles are advantageously between 50% to 1000% larger than the d₉₈ and the d₅₀, respectively, of the pigment particles. Given that the “larger copper-containing biocidal particles” must be injectable into wood, and therefore have a maximum size as defined by the d₉₈, d₉₉, or preferably the d_{99.5} of about 1 micron (diameter), preferably 0.7 microns, more preferably about 0.5 microns or about 0.4 microns, and that in a preferred embodiment these particles often have a d₅₀ size of between 0.1 and 0.2 microns, to have the pigment particles be smaller than the biocidal copper-containing particles, then the pigment particles will typically have a d₅₀ particle size below about 0.1 microns. While it is preferred that the criteria for the d₉₈ and for the d₅₀ are both met, one or the other may not be so long as the biocidal particles having pigment disposed on the outer surface thereof remain injectable.

Finally, in another embodiment the pigment particles are as large or larger, e.g., having a d₅₀ and a d₉₈ between about 1 and 3 times the d₅₀ and a d₉₈ that describe the particle size distribution of the injectable biocidal particles. This embodiment takes advantage of our observation that sub-0.5 micron particles well dispersed in a wood matrix provide less color than did injected slurries of similar weights of larger particles. Advantageously, the larger pigment particles are more visible than the smaller biocidal particles, and therefore have a larger impact on the perceived color, than do the smaller biocidal particles. Another advantage of having larger pigment particles than the average size of the biocidal particles is that if there are agglomerations of particles into a size that is readily visible, then such an agglomeration will almost certainly comprise a large fraction of pigment particles admixed therein which can help mute the color of the agglomeration. While it is preferred that the criteria for the d₉₈ and for the d₅₀ are both met, one or the other may not be so long as the biocidal particles having pigment disposed on the outer surface thereof remain injectable.

In some embodiments, the pigment may be only partially injectable, having for example a d₉₈ of between about 1 and about 2 microns. These infrequent larger pigment particles will have a more difficult time penetrating deeply into wood, but the surface accumulations of the pigments can be beneficial, as opposed to the generally undesired and usually commercial unacceptability of wood having deposits of preservatives disposed on the surface thereof.

In each embodiment where biocidal particulates have pigments and/or dyes associated with the surface thereof, the slurry injected in the wood can further comprise one or more water-soluble dyes in an amount sufficient to color the wood to a color distinguishable from untreated wood. Water-soluble dyes can be added before or after milling the biocidal particles.

Solid inorganic particulate pigments such as iron oxides will not readily adhere to a particle of a solid phase of a slightly soluble salt of for example copper. Particles comprising a solid phase of a slightly soluble salt of for example copper can be coated with an organic coating, for example a coating formed by wet milling the particles with certain dispersants and optionally with certain organic biocides. This can have the effect of creating an exterior surface on the particles comprising a solid phase of a slightly soluble salt of for example copper such that solid pigment material, such as for example iron oxides, can adhere to the biocidal particle. Alternately or additionally, organic dyes can be made to adhere to the particles by selecting dispersants which will adhere to particles and will attract and bind with organic dyes. The biocidal particles on wet ball (or bead) milling will accumulate dispersant on the outer surface thereof, and will additionally accumulate oil-soluble dyes and/or smaller pigment particles, which are often held to the surface of the larger biocidal particle by interaction with the dispersant.

A strongly anionic dispersant is generally recommended to disperse and stabilize a slurry of for example sparingly soluble copper salts in water. Examples of such anionic surfactants or dispersant systems are sodium poly(meth)acrylate, sodium lignosulphonate, naphthalene sulphonate, etc. The term poly(meth)acrylate encompasses polymers comprising a major quantity (e.g., at least 30% by weight, typically at least 50% by weight) of acrylate monomers, e.g., polyacrylates, polymers comprising a major quantity of methacrylate monomers, e.g., polymethacrylates, and polymers comprising a major quantity of combined acrylate-containing and methacrylate-containing monomers. If pigments and/or dyes are cationic in nature, they will be attracted to the anionic dispersant-covered surface of biocidal particulates during milling. Care should be taken not to add an excess of cationic material, or slurry instability and precipitation will result. Formulations to overcome this tendency often utilize extremely high concentrations of anionic dispersants, e.g., the greater of between 5 to 15 grams of surfactants per gram of quaternary ammonium compound, or between 0.8 to 2 grams dispersants per gram of copper-containing particles. Advantageously, if cationic dyes or pigments are added to the surface of the coated biocidal (typically copper-salt-containing) particles, then the dispersant advantageously comprises an effective amount of at least one non-ionic dispersant comprising a hydrophilic polyalkylene oxide portion having between 2 and 50 alkylene oxide units therein and a hydrophobic portion comprising eight or more carbon atoms, wherein the slurry when tested at its intended use concentration is stable if it exhibits suspensibility greater than 80% after thirty minutes when tested according to the Collaborative International Pesticide Analytical Committee Method MT 161. More preferably the slurry comprises non-ionic surfactants comprising etherified compound of said hydrophilic polyalkylene oxide condensation compounds and an aliphatic alcohol or a higher fatty acid. Most preferably the slurry comprises an effective amount of a dispersant comprising a phosphate ester of an etherified compound of hydrophilic polyalkylene oxide condensation compounds and an aliphatic alcohol or a higher fatty acid. Such compounds can better stabilize a slurry and prevent agglomeration of particles mixed with a cationic dye or pigment, e.g, a slurry comprising or consisting essentially of between 0.05 and 0.5 parts cationic dyes and/or pigments and between about 0.5 and about 2 parts of dispersants per part of cationic dye compound, or between 0.1 to 0.5 parts dispersants per part of copper-containing particles.

Wood treated with particles having a solid phase of organic biocide have different characteristic than wood treated with particles having a solid phase of sparingly soluble copper salt, copper(I)oxide, a sparingly soluble zinc salt, and zinc oxide; and/or a sparingly soluble tin salt. First, there is generally much lower quantities of organic biocide per unit volume of wood than there are for wood treated with a sparingly soluble copper or zinc salt, for example. Second, the biocidal particles comprising a solid organic biocide phase are often either a light or a dark color—most organic biocides to not impart a distinct and undesirable color such as the green-gray color obtained from certain copper materials. Third, the organic-based biocidal particles generally do not generate highly colored species as they age. Finally, it is often relatively easy to coat particles having a solid organic biocide phase by simply milling the organic biocide material with particulate pigment, such as for example iron oxides or any of a variety of other pigments, where advantageously the particle size of the pigment is less than one fourth, preferably less than one sixth, such as between one eighth and one twentieth, of the particle diameter of the organic particles being coated. Additionally, organic dyes can be made to adhere to the particles by selecting dispersants which will adhere to particles and will attract organic dyes.

### BRIEF DESCRIPTION OF FIGURES

FIG. 1 shows interior sections of wood blocks showing: (left) an untreated block; (middle) a block treated with injected sparingly soluble copper salt particulates (at 0.22 lb CU/ft³); and (right) a block treated with injected sparingly soluble copper salt particulates (at 0.22 lb Cu/ft³) and developed with a material which stains the wood black when copper is present. It can be seen that there is little or no difference in appearance between untreated wood and wood treated with injected sparingly soluble copper salt particulates (at 0.22 lb Cu/ft³). It can also be seen that the copper particles where present throughout the entire cross section of the block.

FIG. 2 shows on the left a photograph of wood blocks injected with un-milled sparingly soluble copper salt having d₅₀ of 2.5 microns and on the right a photograph of wood injected with milled sparingly soluble copper salt having d₅₀ of ˜0.2 to ˜0.3 microns.

FIG. 3 shows Botrytis Growth Rate (mm²/day) on PDA at four concentrations that were X, 0.67×, 0.33×, and 0.1×. “EXP 1” is a comparative example using a commercially available chlorothalonil product having an average particle size in excess of 2 microns. “EXP. 3” and “EXP 4” are growth rates on PDA treated with wet ball milled submicron chlorothalonil product.

FIG. 4 shows the quantity of copper leached from wood that had been previously treated with prior art CCA and aqueous copper-ethanolamine solutions, as well as the copper leached from wood treated with biocidal slurries of this invention.

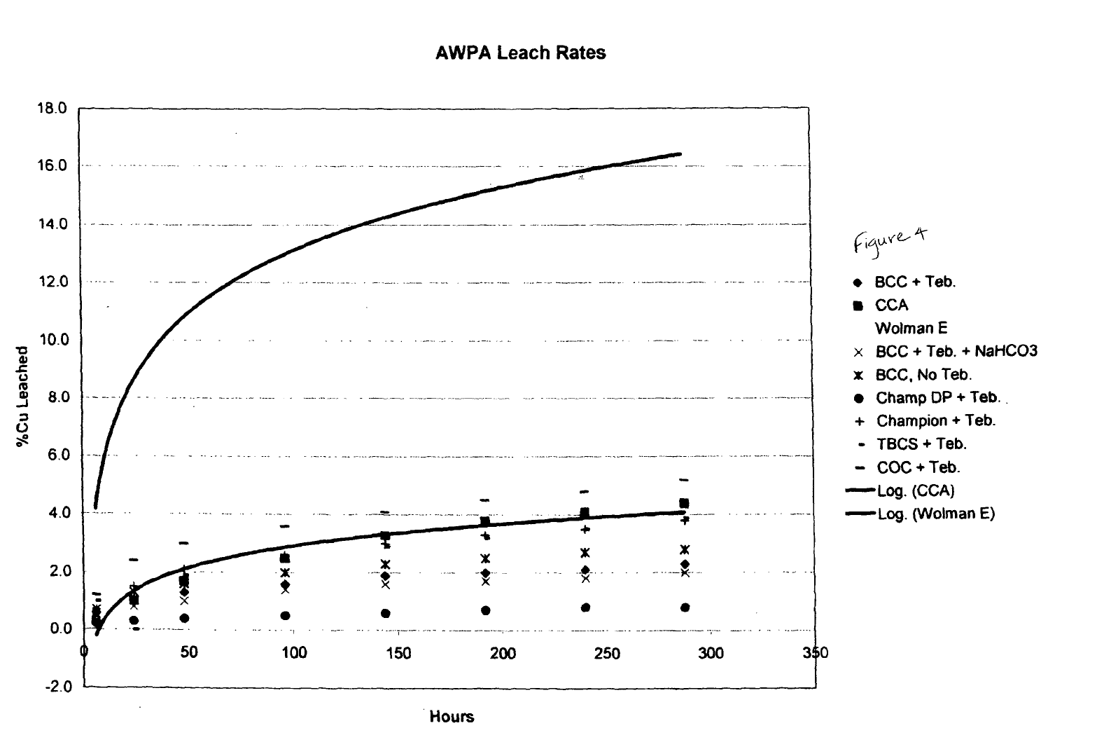

### DESCRIPTION OF PREFERRED EMBODIMENTS

### Preservative Compositions

The injectable wood preservative slurry comprises water and 1) injectable particles having a solid phase of sparingly soluble inorganic biocidal salts and/or injectable particles having a solid phase of substantially insoluble organic biocidal compounds; 2) dispersants; and at least one of 3) organic dyes or 4) inorganic pigments. The mixture can then be incorporated into a slurry or be dried or formulated into a stable concentrated slurry for shipping. The coated particulates are then treated to prevent coalescence by, for example, coating the particle with other adjuvants such as anticoagulants, rosins, waxes, wettability agents, dispersibility agents, and the like. Such a product can be stored, shipped, and sold as a dry pre-mix, but is more advantageously sold as a slurry concentrate.

One particular aspect of the invention relates to an injectable, biocidal slurry containing A) biocidal particles having 1) at least 25% by weight of a solid phase of one or more of sparingly soluble copper-, nickel-, tin-, and/or zinc-salts, hydroxides, or oxides, or having at least 25% by weight of a solid phase comprising or consisting essentially of a substantially insoluble organic biocide that is a solid at ambient temperature, and having an exterior organic coating covering at least a portion of the exterior surface of the biocidal particles; and B) one or more pigments or dyes which are 1) associated with the surface of the biocidal particulates, or 2) are substantially free of and not associated with the surface of the biocidal particulates. Without being bound by theory, it is believed that having the pigment(s)/dye(s) associated with the coating/particulates can have one or more of the following advantages: 1) it is an exceedingly effective way to mask the color of the particle, as only the particle needs to be dyed and not the entire substrate (e.g., wood) to which the composition is introduced (e.g., by injection); 2) it provides a method to visually ensure penetration of a preservative into the substrate (e.g., wood); and 3) it allows the flexibility to associate one or more organic co-biocides and/or dispersants with the coating/biocidal particulates. Advantageously, a preferred method for manufacturing such a composition is by wet milling the pigment(s)/dye(s) with the biocidal particulates. In this embodiment, the preferred milling agent includes or is zirconia, preferably zirconia having an average size/diameter from about 0.2 to about 0.8 mm, more preferably from about 0.3 to about 0.6 mm, for example of about 0.5 mm. In another embodiment, one or more dispersants are included in the milling process.

Another particular aspect of the invention relates to an aqueous injectible, biocidal slurry containing: A) biocidal particles having at least 25% by weight of a solid phase of 1) a sparingly soluble copper salt or hydroxide, 2) a sparingly soluble nickel salt or hydroxide, 3) a sparingly soluble tin salt or hydroxide, 4) a sparingly soluble zinc salt or hydroxide, 5) a substantially insoluble organic biocide that is a solid at ambient temperature; B) dispersants; and C) one or more pigments or dyes which are 1) associated with the surface of the biocidal particulates, or 2) are substantially free of and not associated with the surface of the biocidal particulates. In a preferred embodiment, composition comprises pigment particles wherein the average particle size of the one or more pigments is less than half the particle size of the biocidal particulates.

Another particular aspect of the invention relates to an injectible, biocidal slurry containing biocidal particulates having a solid phase comprising or consisting essentially of a substantially insoluble organic biocide that is a solid at ambient temperature and also having an exterior organic coating, and one or more pigments or dyes associated with the surface of the biocidal particulates.

Another particular aspect of the invention relates to an injectible, biocidal slurry containing A) biocidal particulates having a solid phase comprising or consisting essentially of a sparingly soluble copper salt or hydroxide, a sparingly soluble nickel salt or hydroxide, a sparingly soluble tin salt or hydroxide, a sparingly soluble zinc salt or hydroxide, or any combination thereof, and also having an exterior organic coating, and one or more pigments or dyes associated with the surface of the biocidal particulates.

Another particular aspect of the invention relates to an injectible, biocidal slurry containing A) biocidal particulates having a solid phase comprising or consisting essentially of copper oxide, nickel oxide, tin oxide, zinc oxide, or any combination thereof, and also having an exterior organic coating, and one or more pigments or dyes. In one embodiment, one or more dispersants are co-emulsified with the one or more pigments/dyes.

In another embodiment the invention includes the injectable wood preservative composition, a method of preserving and coloring wood, and preserved wood treated with such a composition, where the preservative composition comprises particulate biocidal particles and one or more pigments or dyes in “an amount sufficient to impart a discernable color to the wood.”

Advantageously, the composition to be injected into wood is a dilute mixture containing between about 96% to about 99.5% water. Shipping and storing such a composition is very difficult. Therefore, advantageously, the composition is prepared in a very concentrated form, for example, as a dry mix or as a slurry concentrate having between 20% and 95% water, more typically between 40% and 80% water, with the remainder comprising biocidally active material, dispersants, pigments, and optionally other adjuvants.

The wood preservative composition can optionally be sold as a dry mix. The dry mix contains particles that comprise the biocidal material and that additionally comprise one or more additives (adjuvants) such as are described as being present in the slurry, including, for example, sparingly soluble biocidal salt particulates having organic biocides disposed as a thin layer on the surface thereof, pigments and/or dyes, antioxidants, surfactants, disbursing agents, chelators, corrosion inhibitors, pH modifiers and/or buffers, and the like. The additives can be coated onto the sparingly soluble metal-based particulates and/or can be formed from separate particulates. The dry-mix material advantageously has all necessary components to form an injectable wood preservative slurry in a single mix, and therefore each slurry component is present in a range that is useful when the dry mix is formed into an injectable slurry. The mixture may optionally but preferably incorporate a granulating material such as a soluble salt, which is a material that when dry holds a plurality of particulates together in the form of a granule, but that dissolves and releases the individual particulates on being admixed with water. Granules are preferred over sub-micron-sized particulates because of dust problems and also the ease of measuring and handling a granular mixture. Granulating agents can be simple soluble salts, that are sprayed onto or otherwise is mixed with the particulate material. Several additives to a slurry can be also used as granulating agents. We have found that such dry mixes usually require some high shear mixing to form an injectable slurry, and the high shear mixing may cause a desired outer layer of material comprising for example dispersants, pigments, dyes, organic biocides, and the like, to be separated from the surface of the particles. An injectable slurry can be prepared by wet milling (using for example milling beads comprising zirconium and having a size between about 0.3 mm to 2 mm) a dry mix with water, but generally such a mill is not available at wood preservation plants. Therefore, dry mixes are not a preferred commercial embodiment.

The wood preservative composition is preferably prepared, sold, shipped, and stored as a wet mix or as a slurry concentrate, and typically such a composition will comprise about 20% to about 85% water. The quantity and type of dispersing agents must inhibit irreversible agglomeration of particles in both the slurry concentrate (which may be stored for weeks or months prior to use) and in the diluted, ready to use slurry which is typically prepared within a few hours of the time the slurry is to be injected into wood. The slurry concentrate may be diluted with water, beneficially fresh water. The selection of adjuvants can provide safeguards against unwanted reactions that might otherwise occur on dilution, such as dissolution of copper or other biocidal metals if the added water is acidic to formation of scale deposits if the added water is “hard” water.

The loading of the biocidal particulates in the slurry to be injected into wood will depend on a variety of factors, including the desired loading in the wood, the porosity of the wood, and the dryness of the wood. Calculating the amount of biocidal particulates in the slurry is well within the skill of one of ordinary skill in the art. Generally, the desired biocide loading into wood is between 0.025 and about 0.5 pounds metal per cubic foot of wood. Advantageously the biocidal particles comprise at least 25%, preferably at least 50%, for example at least 75% of a solid biocidal material. This means that the dispersants, dyes, pigments, absorbed organic biocides, and the like are generally present in an amount that is between about one third to about three times the amount of biocidal material. Similarly, the loading of dyes and/or pigments will depend on the color, whether the pigment is to color the wood or merely disguise or mask the color of the biocides, and whether the dyes are water-soluble, alcohol-soluble, or oil-soluble, and the particle size and distribution of pigment particles.

### DEFINITIONS

If the manufacturer wants wood with a specified color, the dye would be present in an amount sufficient to impart a discernable color to the wood if, when compared to identical wood treated with the same particulate biocidal materials in the same concentration but without the dyes and/or pigments, there is a difference in the color of the wood discernable to a majority of people not afflicted by color blindness. Absence of a visually apparent color, when compared to identical wood treated with the same particulate biocidal materials in the same concentration but without having the pigments and dyes, also satisfies the phrase comprising pigments and/or dyes in “an amount sufficient to impart a discernable color to the wood.” It is often the case that the manufacturer wants the wood to merely not show visual traces of the preservative treatment, especially when the preservative is an undesirable blue or green such as is provided by many copper compounds. In such a case, the preserved wood without the dye and/or pigment has an undesired visually apparent color. Masking such undesirable color, when compared to identical wood treated with the same particulate biocidal materials in the same concentration but without the pigments and/or dyes, would satisfy the phrase comprising pigments and/or dyes in “an amount sufficient to impart a discernable color to the wood.”

As used herein, the terms “particles” and “particulates” are used interchangably. Unless otherwise specified, all compositions are given in “percent”, where the percent is the percent by weight based on the total weight of the entire component, e.g., of the particle, or to the injectable composition. In the event a composition is defined in “parts” of various components, this is parts by weight.

By “bio-active” or “biocidal” we mean the injected preservative treatment, which includes one or more biocides, is sufficiently biocidal to one or more of fungus, mold, insects, and other undesired organisms (pests) which are normally the target of wood preservatives such that these organisms avoid and/or can not thrive in the treated wood.

The biocidal particulates, dyes, and pigments must be injectable. By “injectable” we mean that the wood preservative particulates are able to be pressure-injected into wood, wood products, and the like to depths normally required in the industry, using equipment, pressures, exposure times, and procedures that are the same or that are substantially similar to those currently used in industry. Pressure treatment is a process performed in a closed cylinder that is pressurized, forcing the chemicals into the wood. Unless otherwise specified we mean injectable into normal Southern pine lumber. The particulates are sufficiently distributed through at least an inch of a wood product, preferably through at least 2 inches of wood, so as to provide a biocidal distribution of particulates throughout a solid wood matrix.

Injectability into wood requires the particulates be substantially free of the size and morphology that will tend to accumulate and form a filter cake, generally on or near the surface of the wood, that results in undesirable accumulations on wood in one or more outer portions of the wood and a deficiency in an inner portion of the wood. Injectability is generally a function of the wood itself, as well as the particle size, particle morphology, particle concentration, and the particle size distribution.

Generally, even slurries of small particles usually have a small fraction of particles that are unacceptably large, i.e., a few particles are too big to be injectable. A very small fraction of particles having a particle size above about 1 micron causes, in injection tests on wood specimens, can severely impaired injectability and can make the resulting product not be desirable for use, as biocidal particles that have a size above 1 micron are often visible or when present in sufficient amount impart a readily visible color, which can be an undesirable blue-green such as results from weathering of copper-containing particles on an exterior surface. That is, large biocidal particles or large agglomerations of smaller biocidal particles when injected into wood can impart substantially more undesirable color than for example an equal weight of smaller particles that are dispersed throughout the wood matrix. Additionally, the wood so treated will eventually release biocidal particles that were not injected into the wood but were rather trapped only on the exterior of the wood, thereby creating health and/or environmental hazards. As a result, there should be very few or no large particles, e.g., greater than about 1.5 microns, preferably greater than about 1 micron in diameter. Removal via filtering is not economically effective, as a substantial fraction of injectable particles will be caught on filters designed to remove the bigger particles.

As used herein, particle diameters may be expressed as “dₓₓ” where the “xx” is the weight percent (or alternately the volume percent) of that component having a diameter equal to or less than the dₓₓ. The d₅₀ is the diameter where 50% by weight of the component is in particles having diameters equal to or lower than the d₅₀, while just under 50% of the weight of the component is present in particles having a diameter greater than the d₅₀. Particle diameter is preferably determined by Stokes Law settling velocities of particles in a fluid, for example with a Model LA 700 or a CAPA™ 700 sold by Horiba and Co. Ltd., or a Sedigraph™ 5100T manufactured by Micromeritics, Inc., which uses x-ray detection and bases calculations of size on Stoke's Law, to a size down to about 0.15 microns. Smaller sizes may be determined by a dynamic light scattering method, preferably with a laser-scattering device, but are preferably measured by direct measurements of diameters of a representative number of particles (typically 100 to 400 particles) in SEM photographs of representative sub-0.15 micron material. For particles between about 0.01 microns and about 0.15 microns, the particle size can be determined by taking SEMs of representative particles within the size range and measuring the diameter in two directions (and using the arithmetic average thereof) for a representative sample of particles, for example between 100 particles to about 400 particles, where the relative weight of the particles within this fraction are assumed to be that weight of a spherical particle having a diameter equal to the arithmetic average of the two measured diameters, and wherein the total weight of the sub-0.15 micron fraction is advantageously normalized to a reported “<0.15 micron” fraction determined from the hydrodynamic settling test. Particles having diameters below 0.02 microns are considered to be soluble, and if injected into wood are expected to provide leaching characteristics similar to those provided by injected soluble aqueous copper amine treatments.

Advantageously, both the biocidal particles and the pigments are substantially free of hazardous material. By “substantially free of hazardous material” we mean the preservative treatment is substantially free of materials such as lead, arsenic, chromium, and the like. By substantially free of lead we mean less than about 0.1% by weight, preferably less than about 0.01% by weight, more preferably less than about 0.001% by weight, based on the dry weight of the wood preservative. By substantially free of arsenic we mean less than about 5% by weight, preferably less than about 1% by weight, more preferably less than about 0.1% by weight, for example less than about 0.01% by weight, based on the dry (water-free) weight of the wood preservative. By substantially free of chromium we mean less than about 0.5% by weight, preferably less than about 0.1% by weight, more preferably less than about 0.01% by weight, based on the dry weight of the wood preservative.

Advantageously, the wood preservatives are beneficially substantially free of organic solvents. By substantially free we mean the treatment comprises less than about 10% organic solvents, preferably less than about 5% organic solvents, more preferably less than about 1% organic solvents, for example free of organic solvents, based on the water-free weight of the wood preservative composition. As used herein, ammonium hydroxide, alkanolamines, and amines which can complex copper are considered organic solvents. Biocidal quaternary amines, on the other hand, are not organic solvents. In preferred embodiments of this invention, the slurry is substantially free of alkanolamines, e.g., the slurry comprises less than about 1% alkanolamines, preferably less than about 0.1% alkanolamines, or is completely free of alkanolamines. In preferred embodiments of this invention, the slurry is substantially free of amines, e.g., the slurry comprises less than about 1% amines, preferably less than about 0.1% amines, or is completely free of amines, with the proviso that amines whose primary function is as an organic biocide are excluded from this. In preferred embodiments of this invention, the slurry is substantially free of solvents, e.g., the slurry comprises less than about 1% organic solvents, preferably less than about 0.1% organic solvents, or is completely free of organic solvents.

Pigments and Dyes

There are a large number of pigments and dyes known in the industry, and many are applicable for various embodiments of this invention. Particularly preferred particulate pigments include iron oxides, manganese oxides, tin oxide (when the biocide is not a sparingly soluble tin salt), and zinc oxide (when the biocide is not a sparingly soluble zinc salt); organic dyes such as water soluble dyes, e.g. water soluble aniline dye, a variety of oil soluble wood dyes, a variety of alcohol soluble wood dyes, and known pigments useful for coloring wood such as Van Dyke brown.

A preservative composition may further optionally comprise one or more of flame retardants, staining agents, anti-oxidants, water repellents, and UV-protectors. In a special embodiment of the invention, the dye can be one or more organic UV protectorants. Such a UV protectorant dye can protect wood, but also it can protect submicron biociodal material from degradation by sunlight. Organic biocides and even some inorganic sparingly soluble salts are susceptible to degradation by sunlight, so preferably the UV protectorant dye is disposed on the surface of the particle comprising the susceptible biocidal material. Exemplary useful material include bisbenzophenones and bis(alkyleneoxybenzophenone) ultraviolet light absorbers disclosed in U.S. Pat. No. 6,537,670, ortho-dialkyl aryl substituted triazine ultraviolet light absorbers disclosed in U.S. Pat. No. 6,867,250, polyaminoamides comprising 1,3-diimines disclosed in U.S. Pat. No. 6,887,400, poly-trisaryl-1,3,5-Triazine carbamate ultraviolet light absorbers disclosed in U.S. Pat. No. 6,306,939 and other known long-lasting UV protectorants can be used. The UV protectorants can be dispersed in the biocidal slurry during the wet milling process, where the milling process will disperse and place the UV protectorants on the exterior of biocidal particles in much the same manner that substantially insoluble biocidal material can be placed during wet ball milling on the exterior of biocidal particles. It is important to realize that UV protectorants used to protect biocides are different than UV protectorants applied to wood itself. First, very little protectorant is needed—a reasonable amount may range from between 0.1 parts and 10 parts of an organic UV protectorant per 100 parts by weight of biocidal material.

The pigments/dyes which the formulations according to the invention comprise are not subject to any limitation. They can be organic or inorganic in nature. Suitable organic pigments are, for example, those of the azo, di-azo, polyazo, anthraquinone, or thioindigo series, and furthermore other polycyclic pigments, for example, from the thioindigo, pyrrolopyrrole, perylene, isoamidolin(on)e, flavanthrone, pyranthrone or isoviolanthrone series, phthalocyanine, quinacridone, dioxazine, naphthalenetetracarboxylic acid, perylenetetracarboxylic acid, or isoindoline series, as well as metal complex pigments or laked dyestuffs. Other organic pigments may additionally or alternately include, but are not limited to, aniline dye (water soluble), oil wood dyes (oil soluble), alcohol wood dye (alcohol soluble), or the like, or a combination thereof.

Exemplary suitable inorganic pigments are, for example, metal sulfides such as zinc sulfides, ultramarine, titanium dioxides, iron oxides (e.g. red or yellow iron oxide), iron phosphates, antimony trioxide, nickel- or chromium-antimony-titanium dioxides, cobalt blue, manganese and manganous oxides, manganese borate, barium manganate, and chromium oxides. Generally pigments are insoluble. Note that copper and zinc sulfides are insoluble and are therefore considered to be a pigment as opposed to a sparingly soluble biocide. Any of the above can optionally have some, e.g., between 0.01% and 10%, of the moles of cations therein replaced by copper, zinc, of a combination thereof, though very little copper or zinc would be provided from these pigments.

Iron pigments are preferred for many uses. Examples include FeO, Fe₂O₃, Fe₃O₄, wustite, hematite, magnetite, maghemite, ferrihydrite, delafossite, srebrodolskite, hercynite, galaxite, magnesioferrite, jacobsite, trevorite, cuprospinel, franklinite, chromite, manganochromite, cochromite, nichromite, coulsonite, qandilite, ulvospinel, brunogeierite, iwakiite, donathite, filipstadite, schafarzikite, versiliaite, apuanite, magnesiotaaffeite, bixbyite, akimotoite, ilmenite, ecandrewsite, melanostibite, magnesiohogbomite-2N3S, magnesiohogbomite-6N6S, zincohogbomite, freudenbergite, kamiokite, mengxianminite, yimengite, hawthomeite, haggertyite, batiferrite, nezilovite, magnetoplumbite, zenzenite, lindqvistite, plumboferrite, bartelkeite, landauite, loveringite, lindsleyite, senaite, latrappite, romeite, bismutostibconite, jixianite, muratite, scheteligite, zirconolite, stannomicrolite, ferritungstite, armalcolite, pseudobrookite, pseudorutile, mongshanite, kleberite, squawcreekite, jimenorutile, struverite, tapiolite, ferrotapiolite, tripuhyite, jeppetite, priderite, henrymeyerite, vernadite, ferberite, sanmartinite, wolfrainoixiolite, koragoite, ixiolite, qitianlingite, ferrotitanowodginite, ferrowodganite, ferrocolumbite, ferrotantalite, hiarneite, muskoxite, varlamofite, kazakhstanite, bokite, ekatite, cafarsite, stenhuggarite, lazarenkoite, karibibite, ludlockite, fetiasite, schneiderhohnite, mandarinoite, blakeite, emmonsite, keystoneite, kinichilite, zemannite, walfordite, cuzticite, yecoraite, gramaccioliite, and the like; iron hydroxides such as Fe(OH)₂, Fe(OH)₃, amakinite, bemalite, iowaite, natanite, mushistonite, jeanbandyite, stottite, and the like; iron oxide-hydroxides such as goethite, lepidocrocite, akaganeite, feroxyhyte, magnesiohogbomite-2N2S, ferrohogbomite, nolanite, rinmanite, magnesionigerite, ferronigerite, romeite, jixianite, scheteligite, stannomicrolite, ferritungstite, carboirites, graeserite, derbylite, vernadite, janggunite, carmichaelite, bamfordite, varlamofite, ekatite, karibibite, sonoraite, mackayite, juabite, eztlite, and the like; iron sulfides; iron sulfates, iron sulfites; iron phosphates; iron phosphites; or other iron-containing salts such as rodalquilarite, poughite, and the like; and combinations thereof.

A useful organic pigment is carbon black.

Suitable metallic pigments include, e.g., bronze powders and aluminum pastes. Examples include: Pigment MC 1 brown oxide; White Pigment MC-W, Red such as Bayferrox 120 M, commercially available from Bayer, Hostaperm rotviolett ER 02, commercially available from Hoechst AG, Green such as Sunfast grun 7 264-0414, commercially available from Sun Chemicals; Black such as Spezialschwarz 4, commercially available from Degussa; or the like.

Desirable optional components in the preservative composition of the invention include coated micronized pigments capable of reaction within the structure of the substrate to produce special effects or enhanced preservative efficacy or longevity. For example, certain oil soluble dyes are used alone or in conjunction with pigments to heighten color upon aging. Other dyes and pigments deflecting or absorb damaging UV light effects, or inhibit oxidation. Such dyes are advantageously incorporated into a coating or layer of dispersants and optionally other organic material such as oils and the like, all of which are adhered to biocidal particulates. Useful pigments include basic compounds which can buffer water permeating through wood to a pH between 6 and 8, including for example metal hydroxides such as aluminum hydroxide, alkaline earth carbonates such as calcium carbonate, alkaline earth oxides such as magnesium oxide and calcium oxide, and combinations thereof. Such buffering can retard copper leaching from wood treated with sparingly soluble copper salts. On the other hand, these pigments will eventually be leached from the wood by that same water.

Generally, there is no minimum size for pigment materials, though the upper limits on the size and morphology of the pigments is that pigments should be injectable—whether they exist apart from biocidal particles or are associated with the external surface of biocidal particles. In preferred embodiments of the invention, if particulate pigments are incorporated into the slurry, they have a size distribution with a maximum size following about the same guidelines as the maximum size for biocidal particles, e.g., 1) that substantially all the particles, e.g., greater than about 98% by weight, have a particle size with diameter equal to or less than about 0.5 microns, preferably equal to or less than about 0.3 microns, for example equal to or less than about 0.2 microns, and 2) that substantially no particles, e.g., less than about 0.5% by weight, have a diameter greater than about 1.5 microns, or an average diameter greater than about 1 micron, for example. Unlike for biocidal particles, there is no minimum size for particulate pigments, and particulate pigments having an average diameter between about 0.005 microns and 0.5 microns are useful.

If a composition comprises injectable particles comprising a biocide, preferably where the solid phase of biocidal material comprises at least 25% of the total weight of the particle, than the injectable particles of pigment(s) can be

1) smaller than the biocidal particles: Smaller diameter pigments can be treated to adhere to larger biocidal particles, or, alternatively or additionally, dispersants disposed on the surface of larger biocidal particles can attract and hold a plurality of smaller pigment particles, if a low-shear milling technique such as wet milling (as described herein) is employed. In some cases particles having a solid organic biocide phase may have a plurality of smaller pigment particles imbedded or adhering to the surface thereof by simply milling the organic biocide material with particulate pigment and a dispersant. Advantageously the particle size of the pigment is less than one fourth, preferably less than one sixth, such as between one eighth and one twentieth, of the particle diameter (d₅₀) of the biocidal particles being coated.

2) about the same size as the biocidal particles: If the pigment particles are of about the same size as the biocidal particles, e.g., the d₅₀ of the pigment particles is within a factor of about 2 of the of the biocidal particles, then the pigment particles will have similar suspendability and similar penetration into wood. If the pigment and biocidal particles are of comparable size (e.g., plus or minus 30% of the diameter), than the behavior of the biocidal particles and of the pigment particles when injected into a wood matrix will be similar.

3) larger than the biocidal particles. If the pigment particles are larger than the biocidal particles, than individual pigment particles will be more visible than individual biocidal particles, in the event there are agglomerations of biocidal particles (especially on or near the surface of the wood) then such agglomerations will be prone to collect a substantial amount of the larger more visible pigment particles, thereby partially masking the color of the visible agglomeration.

Additionally, there can be a plurality of pigments, where one pigment is in one of the above three size classifications and another pigment is in a different size classification. Each size embodiment is advantageous in certain situations.

The biocidal pigments will often have dispersant compounds associated with the surface thereof, and therefore the pigment particles can themselves be carrier of for example sparingly soluble or substantially insoluble organic biocides disposed in a thin layer on the exterior surface of pigment particles. Indeed, if pigment particles do not adhere to the biocidal material, the pigment particles will nevertheless have a layer of biocidal material disposed on the outer surface thereof after being wet ball milled with the biocidal particles. While a biocidally insignificant amount of sparingly soluble inorganic metal salts will be disposed on a surface of pigment particles, a much thicker and biocidally effective amount of organic biocides can be coated onto pigment particles as a result of wet milling as discussed infra. Indeed, this may be responsible for at least a portion of the average particle size reduction of solid-phase-organic-biocide-containing particles during wet ball milling. The pigment particles will then further disperse organic biocides in a wood matrix.

Sparingly soluble copper salts, copper hydroxide, copper oxides, sparingly soluble zinc salts, and zinc oxides are specifically excluded from the term “pigment”. Indeed, the reason pigments are often desirable in wood treatment applications is biocidal copper materials themselves are excellent pigments, imparting a discernable but undesirable blue/green/gray hue to the wood.

Generally, pigments are biocidal if they comprise a biocidally effective amount of a biocidal metal e.g., copper and/or zinc if in a minor quantity, where copper and zinc provide less than half (preferably less than one quarter) the equivalents of cations present in the pigment, and if the pigment is sparingly soluble. Various copper and zinc salts that are insoluble, as defined by having a Ksp in water below the minimum value of the Ksp defined here, can be pigments. Very few “insoluble” salts are sufficiently biocidal, though insoluble salts comprising silver as a primary cation are generally biocidal. Another example of a biocidal pigment is a pigment comprising tungstate, which is generally not considered to be biocidal but which may impart a biocidal activity against selected pests in wood.

We additionally exclude metal sparingly soluble salts, hydroxides, and oxides from the category of “pigments” if the principal metal therein is the same metal as forms a major component of the sparingly soluble biocidal material in the biocidal particles. For example, U.S. Pat. No. 5,030,285 teaches pigments comprising zinc oxide, ferric phosphate, and ferrous phosphate, which provides an anti-corrosive effect. Such a combination is advantageously used to preserve wood (if there are at least 3 parts zinc oxide per part of ferric salts), or may advantageously be used in combination with a biocidally effective amount of biocidal particles having a solid phase, usually partially crystalline, of sparingly soluble copper-containing salts, sparingly soluble zinc-containing salts, or with particles comprising a solid phase of sparingly soluble organic biocides, or any combinations thereof. The zinc oxide is not considered to be a pigment, even when combined with a primary biocidal material consisting of an organic biocide and/or a solid phase of sparingly soluble copper salts. The ferric phosphate and ferrous phosphate are pigments.

U.S. Pat. No. 6,830,822, the disclosure of which is incorporated by reference, discloses a number of inorganic nanoparticle pigments materials having a particle size of below about 0.1 microns useful for this invention, including non-stoichiometric (oxygen-deficient) metal oxide pigments such as oxygen-deficient zinc oxide, tin oxide, or iron oxides.

A wide variety of dyes and combinations of dyes can be utilized in the present invention. The dyes may be any of azo dyes, disazo dyes, the anthraquinone dyes, the pyrazalone dyes, the quinophthalone dyes, the phthalocyanine dyes and metal complex dyes. Examples of useful dyes include, but are not limited to one or more of the following:

metal-containing or metal-free phthalocyanine dyes, di-azo type dyes, and arylamide dyes, the metal-containing dyes having copper, cobalt, or nickel, in particular, as the central atom;

Blue 15, Green 7, Yellow 83, Yellow 17, and Carbon Black 7; Solvent Black 3, Solvent Black 7, Solvent Blue 70, Solvent Blue 101, Solvent Blue 59, Solvent Blue 128, Solvent Blue 58, Solvent Blue 102, Solvent Blue 59, Solvent Blue 35, Solvent Blue 36, Solvent Green 2, Solvent Green 3, Solvent Green 20, Solvent Green 23, Solvent Green 24, Solvent Green 25, Solvent Green 26, Solvent Green 28, Disperse Orange 25, Solvent Orange 60, Solvent Orange 3, Solvent Orange 56, Solvent Red 1, Disperse Red 22, Solvent Red 24, Solvent Red 26, Disperse Red 60, Solvent Red 111, Solvent Red 135, Solvent Red 209, Solvent Red 210, Solvent Red 169, Solvent Red 207, Solvent Red 195, Solvent Red 109, Solvent Red 172, Solvent Red 138, Solvent Red 168, Vat Red 1, Vat Red 41, Solvent Yellow 3, Solvent Yellow 30, Solvent Yellow 33, Solvent Yellow 77, Solvent Yellow 93, Solvent Yellow 105, Solvent Yellow 114, Solvent Yellow 163, Solvent Yellow 18, Solvent Yellow 109, Solvent Yellow 72, Solvent Yellow 33, Solvent Yellow 43, Solvent Yellow 79, Solvent Yellow 14, Solvent Yellow 16, Solvent Yellow 129, Solvent Violet 13, Solvent Violet 14, Solvent Violet 26, and Solvent Violet 38;

dye adapted for use in wood available from a variety of commercial sources under a variety of names; for example, Morfast Brown 100, Morfast Black 101, Morfast Yellow 101, and Morfast Blue 105 (commercially available from Morton Thiokol, Inc., Morton Chemical Div.), Brown D, Jet Black, and Wood Black (available from Bruce Chemical Company);

Interacetyl Red, Interacetyl Grey, KCA oil yellow 2G, KCA oil orange E, KCA oil red A, Chromofine Orange 2R550, Chromofine Red B750, Seikafast Yellow M35, Chromofine Green 2G550D, and Chromofine Blue 5275.

Biocdal Particles

One aspect of this invention relates to the method of manufacturing an injectable slurry comprising:

A) at least one pigment or dye selected from:
1) an alcohol-soluble dye and/or water soluble dye,
2) an oil-soluble dye,
3) a wood-injectable organic pigment particle, and
4) a wood-injectable inorganic pigment particle;

B) one or more wood-injectable biocidal particulates comprising at least 25% by weight of a solid phase (which is preferably substantially crystalline and is preferably finely ground) of biocidal material selected from
5) sparingly-soluble copper salts and/or hydroxides such as copper hydroxide, basic copper carbonate, basic copper sulfate, basic copper chloride, basic copper phosphate, basic copper phosphosulfate, and the like,
6) copper(I) oxide,
7) a sparingly-soluble zinc-containing material such as zinc oxide, basic zinc carbonate, zinc hydroxide, zinc phosphate, and the like
8) a sparingly-soluble nickel-containing material such as nickel hydroxide or nickel carbonate,
9) a sparingly-soluble tin-containing material such as finely ground hydroxides or carbonates of tin, or
10) a solid organic biocide or combinations of organic biocides, such as triazoles, quaternary ammonium compounds, carbamides, and other organic biocides, or any combinations thereof; and

C) dispersants in an amount sufficient to keep the slurry containing the above stable, non-agglomerating, and non-settling.

In one embodiment, copper-, magnesium-, and/or zinc-silicofluoride can be used as biocides in the compositions according to the invention. In another embodiment, the biocidal particles may be essentially free of halogen, which means that the weight percent of halogen in the particles is less than about 2.5%. Preferably, the weight percent of halogen in biocidal particles that are essentially free of halogen is less than about 1%. In one embodiment, the biocidal particles are completely free of at least one of the halogens.

In any of the above-described embodiments, the composition can further comprise one or more materials disposed on the exterior of the biocidal particles to inhibit dissolution of the underlying sparingly soluble salts at least for a time necessary to prepare the formulation and inject the prepared wood treatment composition. Certain sparingly soluble salts can be very susceptible to premature dissolution if the slurry is unintentionally formed with an acidic water. The acid-soluble particles can be partially or completely coated with a substantially inert coating, for example, a coating of, e.g., a polymeric material such as a dispersant, or with a thin hydrophobic oil) coating, or an insoluble salt such as a phosphate salt, or any combination thereof. In one embodiment the particles are treated with a dispersing material which is substantially bound to the particles.

As used herein, the term “organic biocide” may include, for example, one or more biocides selected from triazole compounds, quartemary amine compounds, nitroso-amine compounds, halogenated compounds, or organometalic compounds. Exemplary organic biocides can include, but are not limited to, azoles such as azaconazole, bitertanol, propiconazole, difenoconazole, diniconazole, cyproconazole, epoxiconazole, fluquinconazole, flusiazole, flutriafol, hexaconazole, imazalil, imibenconazole, ipconazole, tebuoonazole, tetraconazole, fenbuconazole, metconazole, myclobutanil, perfurazoate, penconazole, bromuconazole, pyrifnox, prochloraz, triadimefon, triadlmenol, triffumizole, or triticonazole; pyrimidinyl carbinoles such as ancymidol, fenarimol, or nuarimol; chlorothalonil; chlorpyriphos; N-cyclohexyldiazeniumdioxy; dichlofluanid; 8-hydroxyquinoline (oxine); isothiazolone; imidacloprid; 3-iodo-2-propynylbutylcarbamate tebuconazole; 2-(thiocyanomethylthio) benzothiazole (Busan 30); tributyltin oxide; propiconazole; synthetic pyrethroids; 2-amino-pyrimidine such as bupirimate, dimethirimol or ethirimol; morpholines such as dodemorph, fenpropidin, fenpropimorph, spiroxanin or tridemorph; anilinopyrimdines such as cyprodinil, pyrimethanil or mepanipyrim; pyrroles such as fenpiclonil or fludioxonil; phenylamides such as benalaxyl, firalaxyl, metalaxyl, R-metalaxyl, ofurace or oxadixyl; benzimidazoles such as benomyl, carbendazim, debacarb, fuberidazole or thiabendazole; dicarboximides such as chlozolinate, dichlozoline, iprdine, myclozoline, procymidone or vinclozolin; carboxamides such as carboxin, fenfuram, flutolanil, mepronil, oxycarboxin or thifluzamide; guanidines such as guazatne, dodine or iminoctadine; strobilurines such as azoxystrobin, kresoxim-methyl, metominostrobin, SSF-129, methyl 2-[(2-trifluoromethyl)pyrid-yloxymethyl]-3methoxycacrylate or 2-[α{[(α-methyl-3-trifluoromethyl-benzyl)imino]oxy}-o-tolyl]glyoxylic acid-methylester-O-methyloxime (trifloxystrobin); dithiocarbamates such as ferbam, mancozeb, maneb, metiram, propineb, thiram, zineb, or ziram; N-halomethylthio-dicarboximides such as captafol, captan, dichlofluanid, fluorormide, folpet, or tolfluanid; nitrophenol derivatives such as dinocap or nitrothal-isopropyl; organophosphorous derivatives such as edifenphos, iprobenphos, isoprothiolane, phosdiphen, pyrazophos, or toclofos-methyl; and other compounds of diverse structures such as aciberolar-S-methyl, anilazine, blasticidin-S, chinomethionat, chloroneb, chlorothalonil, cymoxanil, dichione, dicomezine, dicloran, diethofencarb, dimethomorph, dithianon, etridiazole, famoxadone, fenamidone, fentin, ferimzone, fluazinam, flusuffamide, fenhexamid, fosetyl-alurinium, hymexazol, kasugamycin, methasuifocarb, pencycuron, phthalide, polyoxins, probenazole, propamocarb, pyroquilon, quinoxyfen, quintozene, sulfur, triazoxide, tricyclazole, triforine, validamycin, (S)-5-methyl-2-methylthio-5-phenyl-3-phenyl-amino-3,5-dihydroimidazolone (RPA 407213), 3,5-dichloro-N-(3-chloro-1-ethyl-1-methyl-2-oxopropyl)-4-methylbenzamide (RH7281), N-alkyl-4,5-dimethyl-2-timethylsilythiophene-3-carboxamide (MON 65500), 4-chloro-4-cyano-N,N-dimethyl-5-p-tolylimidazole-1-sulfonamide (IKF-916), N-(1-cyano-1,2-dimethylpropyl)-2-(2,4-dichlorophenoxyy)-propionamide (AC 382042), iprovalicarb (SZX 722), or quaternary ammonium compounds of general formula of N—R₁R₂R₃R₄—X, wherein R₁, R₂, R₃ and R₄ are selected from the group consisting of hydrogen, a C₁ to C₁₈ alkyl, a C₁ to C₁₈ alkoxy, a C₁ to C₁₈ alkenyl, a C₁ to C₁₈ alkynyl, a C₅ to C₁₂ aryl, a C₅ to C₁₂ aralkyl, or a C₅ to C₁₂ aroyl, wherein at least two R groups are not hydrogen and at least one R group comprises six or more carbon atoms (for example, a didecyl-dimethyl-ammonium salt), and wherein X is selected from the group consisting of hydroxide, chloride, fluoride, bromide, carbonate, bicarbonate, sulfate, nitrate, acetate, phosphate, or any mixture thereof. Also included are the biocides including pentachlorophenol, phenothrin, phenthoate, phorate, as well as trifluoromethylpyrrole carboxamides and trifluoromethylpyrrolethioamides described in U.S. Pat. No. 6,699,818; triazoles such as amitrole, azocylotin, bitertanol, fenbuconazole, fenchlorazole, fenethanil, fluquinconazole, flusilazole, flutriafol, imibenconazole, isozofos, myclobutanil, metconazole, epoxyconazole, paclobutrazol, (±)-cis-1-(4-chlorophenyl)-2-(1H-1,2,4-triazol-1-yl)-cycloheptanol, tetraconazole, triadimefon, triadimenol, triapenthenol, triflumizole, triticonazole, uniconazole and their metal salts and acid adducts; Imidazoles such as Imazalil, pefurazoate, prochloraz, triflumizole, 2-(1-tert-butyl)-1-(2-chlorophenyl)-3-(1,2,4-triazol-1-yl)-propan-2-ol, thiazolecarboxanilides such as 2′,6′-dibromo-2-methyl-4-trifluoromethoxy-4′-trifluoromethyl-1,3-thiazole-5-carboxanilide, azaconazole, bromuconazole, cyproconazole, dichlobutrazol, diniconazole, hexaconazole, metconazole, penconazole, epoxyconazole, methyl (E)-methoximino[α-(o-tolyloxy)-o-tolyl)]acetate, methyl (E)-2-{2-[6-(2-cyanophenoxy)-pyrimidin-4-yl-oxy]phenyl}-3-methoxyacrylate, methfuroxam, carboxin, fenpiclonil, 4(2,2-difluoro-1,3-benzodioxol-4-yl)-1H-pyrrole-3-carbonitrile, butenafine, 3-iodo-2-propinyl n-butylcarbamate; triazoles such as described in U.S. Pat. Nos. 5,624,916, 5,527,816, and 5,462,931; the biocides described in U.S. Pat. No. 5,874,025; 5-[(4-chlorophenyl)methyl]-2,2-dimethyl-1-(1H-1,2,4-triazol-1-yl-methyl)cyclopentanol; imidacloprid, 1-[(6-chloro-3-pyridinyl)-methyl]4,5-dihydro-N-nitro-1H-imidazole-2-amine; methyl(E)-2-[2-[6-(2-cyanophenoxy)pyrimidin-4-yloxy]phenyl]3-methoxyacrylate, methyl(E)-2-[2-[6-(2-thioamidophenoxy)pyrimidin-4-yloxy]phenyl]-3-methoxyacrylate, methyl(E)-2-[2-[6-(2-fluorophenoxy)pyrimidin-4-yloxy]phenyl]-3-methoxyacrylate, methyl(E)-2-[2-[6-(2,6-difluorophenoxy)pyrimidin-4-yloxy]phenyl]-3-methoxyacrylate, methyl(E)-2-[2-[3-(pyrimidin-2-yloxy)phenoxy]phenyl]-3-methoxyacrylate, methyl(E)-2-[2-[3-(5-methylpyrimidin-2-yloxy)-phenoxy]phenyl]-3-methoxyacrylate, methyl(E)-2-[2-[3-(phenylsulphonyloxy)phenoxy]phenyl]-3-methoxyacrylate, methyl(E)-2-[2-[3-(4-nitrophenoxy)phenoxy]phenyl]-3-methoxyacrylate, methyl(E)-2-[2-phenoxyphenyl]-3-methoxyacrylate, methyl(E)-2-[2-(3,5-dimethylbenzoyl)pyrrol-1-yl]-3-methoxyacrylate, methyl(E)-2-[2-(3-methoxyphenoxy)phenyl]-3-methoxyacrylate, methyl(E)-2-[2-(2-phenylethen-1-yl)-phenyl]-3-methoxyacrylate, methyl(E)-2-[2-(3,5-dichlorophenoxy)pyridin-3-yl]-3-methoxyacrylate, methyl(E)-2-(2-(3-(1,1,2,2-tetrafluoroethoxy)phenoxy)phenyl)-3-methoxyacrylate, methyl(E)-2-(2-[3-(α-hydroxybenzyl)phenoxy]phenyl)-3-methoxyacrylate, methyl(E)-2-(2-(4-phenoxypyridin-2-yloxy)phenyl)-3-methoxyacrylate, methyl(E)-2-[2-(3-n-propyloxyphenoxy)phenyl]-3-methoxyacrylate, methyl(E)-2-[2-(3-isopropyloxyphenoxy)phenyl]-3-methoxyacrylate, methyl(E)-2-[2-[3-(2-fluorophenoxy)phenoxy]phenyl]-3-methoxyacrylate, methyl(E)-2-[2-(3-ethoxyphenoxy)phenyl]-3-methoxyacrylate, methyl(E)-2-[2-(4-tert-butylpyridin-2-yloxy)phenyl]-3-methoxyacrylate; fenfuram, furcarbanil, cyclafluramid, furmecyclox, seedvax, metsulfovax, pyrocarbolid, oxycarboxin, shirlan, mebenil (mepronil), benodanil, flutolanil; benzimidazoles such as carbendazim, benomyl, furathiocarb, fuberidazole, thiophonatmethyl, thiabendazole or their salts; morpholine derivatives such as tridemorph, fenpropimorph, falimorph, dimethomorph, dodemorph; aldimorph, fenpropidine, and their arylsulphonates, such as, for example, p-toluenesulphonic acid and p-dodecylphenylsulphonic acid; benzothiazoles such as 2-mercaptobenzothiazole; benzamides such as 2,6-dichloro-N-(4-trifluoromethylbenzyl)-benzamide; formaldehyde and formaldehyde-releasing compounds such as benzyl alcohol mono(poly)-hemiformal; oxazolidine; hexa-hydro-S-triazines; N-methylolchloroacetamide; paraformaldehyde; nitropyrin; oxolinic acid; tecloftalam; tris-N-(cyclohexyldiazeneiumdioxy)-aluminium; N-(cyclohexyldiazeneiumdioxy)-tributyltin; N-octyl-isothiazolin-3-one; 4,5-trimethylene-isothiazolinone; 4,5-benzoisothiazolinone; N-methylolchloroacetamide; pyrethroids such as allethrin, alphamethrin, bioresmethrin, byfenthrin, cycloprothrin, cyfluthrin, decamethrin, cyhalothrin, cypennethrin, deltamethrin, α-cyano-3-phenyl-2-methylbenzyl-2,2-dimethyl-3-(2-chloro-2-trifluoro-methylvinyl)cyclopropane-carboxylate, fenpropathrin, fenfluthrin, fenvalerate, flucythrinate, flumethrin, fluvalinate, permethrin, resmethrin, and tralomethrin; nitroimines and nitromethylenes such as 1-[(6-chloro-3-pyridinyl)-methyl]-4,5-dihydro-N-nitro-1H-imidazol-2-amine (imidacloprid), N-[(6-chloro-3-pyridyl)methyl]-N²-cyano-N¹-methylacetamide (NI-25); quaternary ammonium compounds such as didecyldimethylammonium salts, benzyldimethyltetradecylammonium chloride, benzyldimethyldodecylammonium chloride, didecyldimethaylammonium chloride, and the like; phenol derivatives such as tribromophenol, tetrachlorophenol, 3-methyl-4-chlorophenol, 3,5-dimethyl-4-chlorophenol, phenoxyethanol, dichlorophene, o-phenylphenol, m-phenylphenol, p-phenylphenol, 2-benzyl-4-chlorophenol, and their alkali metal and alkaline earth metal salts; iodine derivatives such as diiodomethyl p-tolyl sulphone, 3-iodo-2-propinyl alcohol, 4-chloro-phenyl-3-iodopropargyl formal, 3-bromo-2,3-diiodo-2-propenyl ethylcarbamate, 2,3,3-triiodoallyl alcohol, 3-bromo-2,3-diiodo-2-propenyl alcohol, 3-iodo-2-propinyl n-butylcarbamate, 3-iodo-2-propinyl n-hexylcarbamate, 3-iodo-2-propinyl cyclohexyl-carbamate, 3-iodo-2-propinyl phenylcarbamate, and the like; microbicides having an activated halogen group such as chloroacetamide, bronopol, bronidox, tectamer, such as 2-bromo-2-nitro-1,3-propanediol, 2-bromo-4′-hydroxy-acetophenone, 2,2-dibromo-3-nitrile-propionamide, 1,2-dibromo-2,4-dicyanobutane, β-bromo-β-nitrostyrene, and the like; and the like; and combinations thereof. These are merely exemplary of the known and useful biocides, and the list could easily extend further. Those compounds that form a solid phase can be used to form particulates, while liquid organic biocides are advantageously incorporated onto other injectable biocidal particles.

More preferred organic biocides include chlorothalonil, IPBC (iodo-propynyl butyl carbamate) azoles/triazoles such as N-alkylated tolytriazoles, metconazole, imidacloprid, hexaconazole, azaconazole, propiconazole, tebuconazole, cyproconazole, bromoconazole, and tridemorph tebuconazole, copper-8-quinolate, fipronil, imidacloprid, bifenthrin, carbaryl, strobulurin biocides such as azoxystrobin and trifloxystrobin, indoxacarb; moldicides; HDO (available commercially by BASF); or mixtures thereof.

By “substantially insoluble” (or “sparingly soluble” as the term relates to inorganic biocides such as salts), we mean the organic biocide has a solubility in water of less than about 0.1%, and most preferably less than about 0.01%, for example in an amount of between about 0.005 ppm and about 1000 ppm, alternatively between about 0.1 ppm and about 100 ppm or between about 0.01 ppm and about 200 ppm, in water. The terms “sparingly soluble” and “substantially insoluble” are generally used interchangably herein, though in a direct comparison a substantially insoluble material is expected to have a lower solubility in water than is a sparingly soluble material. A “sparingly soluble” salt, e.g., a copper salt, a zinc salt, a tin salt or the like, as used herein advantageously has a Kₛₚ in pure water between about 10⁻⁸ to about 10⁻²⁴ for salts with only one anion, and from about 10⁻¹² to about 10⁻²⁷ for salts with two anions. Preferred sparingly soluble copper- and zinc-containing salts have a Kₛₚ between about 10⁻¹⁰ to about 10⁻²¹. As used herein, preferred sparingly soluble inorganic salts includes salts with a Kₛₚ of between about 10⁻¹² to about 10⁻²⁴ for salts with only one anion, and from about 10⁻¹⁴ to about 10⁻²⁷ for salts with two anions. However, sparingly soluble silver salts have greater efficacy at low concentrations, and salts with a Kₛₚ of between about 10⁻²⁰ to about 10⁻⁴⁰ are useful.

The most preferred biocidal particles are substantially round, e.g., the diameter in one direction is within a factor of two of the diameter measured in a different direction, wherein particles having an average diameter (d₅₀, as measured by hydrodynamic settling) greater than 0.1 microns and less than 0.5 microns; and also 1) that substantially all the particles, e.g. greater than about 98% by weight, preferably greater than 99%, for example greater than 99.5% by weight have a particle size with diameter equal to or less than about 0.5 microns, preferably equal to or less than about 0.3 microns, for example equal to or less than about 0.2 microns, and 2) that substantially no particles, e.g., less than about 0.5% by weight, have a diameter greater than about 1.5 microns, or an average diameter greater than about 1 micron, for example. We believe the first criteria primarily addresses the phenomena of bridging and subsequent plugging of pore throats, and the second criteria addresses the phenomena of forming a filter cake. Once a pore throat is partially plugged, complete plugging and undesired buildup generally quickly ensues.

However, there are also minimum preferred particulate diameters for the biocides incorporated into the wood treatment, which depend somewhat on the biocides, particularly the sparingly soluble copper and/or zinc salts, that are in the particulates. If the sparingly soluble salts have a high solubility, then very small particulates having a large surface to mass ratio will result in too high an initial metal ion concentration, and too fast a rate of metal leaching, compared to preferred embodiments of this invention. Generally, it is preferred that at least about 80% by weight of the biocidal particles be above about 0.02 microns in diameter, preferably greater than about 0.04 microns, for example greater than about 0.06 microns in diameter. It is also preferred that at least 50% by weight of the injectable biocidal particles have an average diameter greater than about 0.06 microns, for example between about 0.08 microns and about 0.18 microns. In alternative preferred embodiments of this invention, at least about 50% by weight of the biocide-containing particulates have a size greater than about 40 nanometers. In one preferred embodiment, at least about 80% by weight of the biocide-containing particulates have a size between about 0.05 microns and about 0.4 microns.

In a most preferred embodiment, the sparingly soluble (and preferably substantially crystalline) metal-based particulates advantageously have an average diameter d50 between about 0.1 and about 0.4 microns. The particle size distribution of the particulates is typically such that less than about 1% by weight, preferably less than about 0.5% by weight, of the particulates have an average diameter greater than 1 micron. Preferably the particle size distribution of the particulates is such that less than about 1% by weight, preferably less than about 0.5% by weight, of the particulates have an average diameter greater than about 0.7 microns. Additionally, the particle size distribution of the particulates is such that at least about 30% by weight of the particulates have an average diameter between about 0.07 microns and about 0.5 microns. In a preferred embodiment, the particle size distribution of the particulates is such that at least about 50% by weight of the particulates have an average diameter between about 0.07 microns and about 0.5 microns, for example between about 0.1 microns and about 0.4 microns.

Biocidal particulates are preferably finely ground or finely milled, where the phrases are used interchangably. The term “finely ground” means the material has been subjected to size attrition via a milling procedure, and that the material after the milling procedure had: a d₉₉ of less than 2 microns, preferably less than 1.4 microns, more preferably less than 1 microns, but generally greater than about 0.3 microns, for example between about 0.4 and 0.8 microns; a d₉₈ of less than 2 microns, preferably less than 1 micron, more preferably less than 0.8 microns, but generally greater than about 0.3 microns, for example between about 0.4 and 0.8 microns; a d₅₀ of less than 0.9 microns, preferably less than 0.7 microns, more preferably less than 0.5 microns, but generally greater than about 0.1 microns, for example between about 0.1 and 0.3 microns; and a d₃₀ of greater than 0.02 microns, preferably greater than 0.04 microns, more preferably greater than 0.06 microns, but generally less than about 0.2 microns, for example between about 0.06 and 0.15 microns.

The milled metal-based particles described above are readily slurried and injected into wood after the milling process. Generally, however, milling is done well before the particles are slurried and injected. The particles may be shipped in a dry form or in a wet form. The milled particles may be transported to a site as a dry mix or as a concentrated slurry, which is then formed into an injectable slurry, and then after some indeterminate storage time the particles may be injected into wood. Particulates in solution have a tendency to grow over time by 1) the thermodynamically driven tendency of sub-micron particles in solution to grow by a dissolution/re-precipitation process, where there is a greater tendency for small particles to slowly dissolve and for the salts to re-precipitate on the larger crystals. It is not uncommon in unstabilized slurries, for the median particle size to increase by about 50% over a period of a day or two. A commercially useful particulate-based wood preservation product must simultaneously achieve the critical particle size, particle size distribution, and particle stability in an injectable slurry at a location where wood is preserved at a cost where the material will be commercially used. Therefore, it is advantageous to have a coating on the particle to substantially hinder dissolution of a particle that is more than sparingly soluble while the particle is slurried. But, the coating should not overly hinder dissolution of the particle in the wood matrix.

The biocidal material can be stabilized by a partial or full coating of an insoluble inorganic salt of such low thickness that the coating will not substantially hinder particle dissolution in the wood. The preferred coatings are very low solubility metal salts of the underlying metal cations which can substantially arrest the dissolution/re-precipitation process by severely limiting the amount of metal that can dissolve. The coating, however, is typically intended as a mechanical protection. Exposed portions of sparingly soluble biocidal salts, for example portions exposed due to abrasion of particles by machinery or by one another, are still subject to dissolution. An insoluble inorganic coating can be formed during and immediately after the particulate precipitation process, for example, by adding the insoluble-salt-forming anion (typically phosphate) to a precipitating salt composition. Such a process is very dependent on timing and is susceptible to error. More advantageously, biocidal particles may be wet-milled using a very fine milling material and a fluid containing a source of the insoluble-salt-forming anions, e.g., sulfate ions, phosphate ions, or less preferably (because of odor and handling problems) sulfide ions. Such milling in the anion-containing milling fluid, for example for a time ranging from 5 minutes to 4 hours, typically from 10 minutes to 30 minutes promotes the formation of a thin coating of metal salt over the sparingly soluble metal salts. The invention also embraces embodiments where particles are substantially free of an inorganic coating.

Biocidal particles may additionally comprise an organic coating, e.g., a organic layer that partially or completely covers the exterior surface area of the particulates. Such a coating is less than 0.5 microns thick, and is typically between about 0.01 and 0.1 microns thick. The protective organic layer may comprise 1) a dispersing/anti-aggregation/wettability modifying dispersant, 2) a light oil and/or similar water-insoluble material such as wood rosin, rosin derivatives, waxes, fatty derivatives, or mixtures, 3) an organic biocide that is a liquid at ambient temperature or is a solid but is solubilized within the organic coating, 4) a dye that is a liquid at ambient temperature or is a solid but is solubilized within the organic coating, and 5) pigments which are associated with the organic layer. While such coatings can be formed in a wet milling process, heating a mixture of particulates and the organic composition may in certain cases help the organic composition wet and adhere to the particulates. The organic coating generally becomes more adherent if the coated particulates are allowed to age, and or are subjected to heat, for example to 35° C. or above, for a period of about an hour, for example.

Dispersants

The slurries include dispersants that adhere to biocidal particles, pigments, or both, and promote stability of the slurry by retarding agglomeration of particles in the slurry. Advantageously, the dispersants can also fix pigments or dyes to the external surface of biocidal particles. A strongly anionic dispersant is generally recommended to disperse and stabilize a slurry of for example sparingly soluble copper salts in water. Examples of such anionic surfactants or dispersant systems are sodium poly(meth)acrylate, sodium lignosulphonate, naphthalene sulphonate, etc. If pigments and/or dyes are cationic in nature, they will be attracted to the anionic dispersant-covered surface of biocidal particulates during milling. Care should be taken not to add an excess of cationic material, or slurry instability and precipitation will result. Formulations to overcome this tendency often utilize extremely high concentrations of anionic dispersants, e.g., the greater of between 5 to 15 grams of surfactants per gram of quaternary ammonium compound, or between 0.8 to 2 grams dispersants per gram of copper-containing particles.

Advantageously, if cationic dyes or pigments are added to the surface of the coated biocidal (typically copper-salt-containing) particles, then the dispersant advantageously comprises an effective amount of at least one non-ionic dispersant comprising an etherfied hydrophilic polyalkylene oxide portion having between 2 and 50 alkylene oxide units therein and a hydrophobic portion comprising eight or more carbon atoms, for example comprising an etherified compound of said hydrophilic polyalkylene oxide condensation compounds and an aliphatic alcohol or a higher fatty acid. Most preferably the slurry comprises an effective amount of a dispersant comprising a phosphate ester of an etherified compound of hydrophilic polyalkylene oxide condensation compounds and an aliphatic alcohol or a higher fatty acid. Such compounds can better stabilize a slurry and prevent agglomeration of particles mixed with a cationic dye or pigment, e.g, a slurry comprising or consisting essentially of between 0.05 and 0.5 parts cationic dyes and/or pigments and between about 0.5 and about 2 parts of dispersants per part of cationic dye compound, or between 0.1 to 0.5 parts dispersants per part of copper-containing particles.

Other dispersants for pigments may be used, e.g., phosphoric esters as emulsifiers and dispersants for pigments and fillers disclosed in U.S. Pat. No. 6,689,731 may be used. Such dispersants can be based on polystyrene-block (b)-polyalkylene oxide copolymers, e.g., block copolymeric phosphoric esters and their salts having the general formula: [R¹—O—(SO)ₐ-(EO)_{b}—(CH₂—CH(CH₃)—O)_{c}—(BO)_{d}]ₓ—PO(OH)₃₋ₓ, where R¹ is a straight-chain or branched or cycloaliphatic radical having from about 1 to about 22 carbon atoms; SO represents styrene oxide; EO represents ethylene oxide; BO represents butylene oxide; and a ranges from about 1 to less than 2, b ranges from about 3 to about 100, c ranges from 0 to about 10, d ranges from 0 to about 3, x is 1 or 2, and b≧a+c+d. Other phosphoric esters that are useful as dispersants are known and can be found in for instance U.S. Pat. No. 4,720,514, which describes phosphoric esters of a series of alkylphenol ethoxylates which may be used advantageously to formulate aqueous pigment dispersions. Phosphoric esters for a similar application are described by European Patent No. EP-A-0256427. Furthermore, German Patent No. DE-3542441 discloses bisphosphoric monoesters of block copolymers and salts thereof. It also describes their possible use as dispersants and emulsifiers, in particular for preparing crop protection formulations. U.S. Pat. No. 4,872,916 describes the use of phosphoric esters based on alkylene oxides of straight-chain or branched aliphatics as pigment dispersants. Similarly, U.S. Pat. No. 3,874,891 describes the use of corresponding sulfates. U.S. Pat. No. 4,456,486 describes, inter alia, acidic or neutral phosphoric esters of fatty alcohols and alkoxylated fatty alcohols as treatment compositions for certain blue pigments. Similarly, European Patent No. EP-A-256427 describes the use of phosphoric esters of alkoxylated fatty alcohols to prepare pigment dispersions said to be suitable for aqueous applications. U.S. Pat. No. 4,720,514 describes pigment dispersions prepared using phosphoric esters of alkoxylates of differing structure. U.S. Pat. No. 4,698,099 describes pigment dispersions comprising, as dispersants, phosphoric esters of monohydroxy-terminated polyesters. U.S. Pat. No. 5,582,638 teaches that the use of phosphoric acid esters and their salts as dispersion agents and dispersion stabilizers for pigments in dyes, paints, and synthetic resins is known, e.g., from German Patent No. DE-A-3 930 687. Additionally or alternately, combinations of pigment and surfactant/dispersants, such as those disclosed in U.S. Pat. No. 5,855,662, may be used. Such pigment/dispersant combinations can be based on, e.g., an oxyalkylation product which is obtained by addition of optionally substituted styrenes onto optionally substituted phenols and reaction with ethylene oxide and/or propylene oxide, and a polyether-polyol having a boiling point of greater than about 150° C. Such materials are advantageously wet milled prior to injection into wood.

If a dispersing agent is present in the preservative composition according to the invention, the ratio of the weight of solid-phase biocide to the weight of dispersing agent present in the suspension may be at least about 1 to 1, for example at least about 5 to 1, alternately at least about 10 to 1, at least about 15 to 1, at least about 20 to 1, or at least about 30 to 1.

Other Adjuvants

A preservative composition may further optionally comprise one or more of flame retardants, staining agents, anti-oxidants, water repellents, UV-protectors, anti-foam agents, wetting aids, adhesion promoters, and freeze-thaw stabilizers. In one embodiment, the wood preservative composition further comprises a soluble copper-amine complex. Preferably, the wood composition does not comprise a soluble copper-amine complex.

We have disclosed here that leaching, and therefore presumably dissolution of sparingly soluble copper salts can be substantially inhibited by added between about 0.1 parts to about 100 parts of organic material per 100 parts of sparingly soluble biocidal salts. A requirement is that the organic material be wet ball milled with the biocidal material, such that the materials are brought into repeated hard contact but without applying large amounts of shear force (such as might be applied by a high speed impeller mixer. The organic material and inorganic material become associated with one another on what could best be called composite particles. In the examples, one part of the substantially insoluble biocide TEB when milled with 60 parts of submicron copper hydroxide reduced the resultant leach rate of copper from wood injected with the slurry by 20%. A variety of organic materials can be added to the surface of biocidal particles and subsequently retard dissolution of the salt and metal leaching from wood. In addition to dispersants and substantially insoluble biocides that coated biocidal particles disclosed in the examples, other organic material can include UV protectorants, pigment particles, dyes (especially oil soluble dyes), oils, or combinations thereof can be dispersed in the biocidal slurry concentrate during the wet milling process, where the milling process will disperse and place the UV protectorants, substantially insoluble organic biocides, dyes, and/or oils onto the outer surface of biocidal particles in much the same manner that substantially insoluble biocidal material can be placed during wet ball milling on the exterior of biocidal particles. It is important to realize that UV protectorants used to protect biocides are different than UV protectorants applied to wood itself. First, very little protectorant is needed to protect the biocidal material—the amount needed is generally well below one percent of the amount needed to protect the wood surface itself. For each organic component expected to be coated onto a surface of a biocidal particle, excluding surfactants and dispersants which are discussed elsewhere in this application, a reasonable amount may range from between 0.1 parts and 10 parts of an organic UV protectorant, oil, dye, resins, and the like per 100 parts by weight of biocidal material.

If a biocidal slurry comprises at least one type of injectable biocidal particle that is within the guidelines set forth in the specification and claims, in an alternate embodiment of the invention the slurry can further comprise one or more biocidal oxides, for example one or more of CuO, Cu2O, and ZnO, wherein such particles have an average particle size less than one half the average particle size of the primary biocidal particles. Such small particles can be used to assist in milling organic biocidal material, can block UV rays, and even can be associated with the outer surface of the larger biocidal particle and inhibit dissolution thereof. In other words, in this alternate embodiment “biocidal oxides” such as copper(I) oxide, copper(II)oxide, and/or zinc oxide can be added to a wood preservation slurry, in much the same manner that one would add for example sub-0.1 micron sized iron oxide pigments (which function as pigments and UV protectorants). For example, the 0.01 to 0.08 particle size zinc oxide such as is described in U.S. Pat. No. 6,342,556 can advantageously be added to a slurry concentrate which is subsequently wet ball milled, so that the very small zinc oxide becomes associated with larger biocidal particles, and/or becomes associated with sufficient organic material that it is of a size and surface composition where rapid dissolution and/or flushing of the sub-0.1 micron in diameter particles from wood can be impeded. Of the biocidal oxides, zinc is preferred. Suitable sub-0.1 micron zinc oxides is available under the trade designation of “Nyacol DP-5370” from Nyacol Products, Inc., (Valley Forge, Pa.), or it can be produced by wet ball milling with 0.3 mm to 0.5 mm zirconia milling media Copper oxides are not preferred, and are advantageously not includes as a pigment, as such particles may be flushed from the wood and create an environmental problem with aquatic environments.

The slurry formulations mentioned can be prepared in a manner known by one skilled in the art, for example, by mixing the active compounds with the liquid carrier, and including emulsifier, dispersants and/or binders or fixative, and other processing auxiliaries. Particulates can be provided in a concentrated slurry, in a very concentrated paste, as dry particulates, as coated dry particulates, as part of a dry pre-mix, or any combination thereof. The slurry concentrate can optionally but advantageously further comprise one or more of an antioxidant such as a sulfite, one or more surfactants, one or more pH modifiers, one or more viscosity modifiers, one or more chelator/scale preventors such as HEDP, and one or more emulsified or solubilized organic biocides. Generally, any of the above can individually be present in an amount between about 0.0001% to 3%, but are usually present in amounts between 0.05% and 1%. The cumulative concentration of these adjuvants is generally less than 5% of the injected slurry.

In a preferred embodiment, the liquid carrier consists essentially of water and optionally one or more additives to aid particulate dispersion, to provide pH maintenance, to modify interfacial tension (surfactants), and/or to act as anticoagulants. In another embodiment, the carrier consists essentially of water, optionally one or more additives to aid particulate dispersion, to provide pH maintenance, to modify interfacial tension (surfactants), and/or to act as anticoagulants; and an emulsion of oil or surfactants comprising organic biocides, oil-soluble dyes, or both dissolved and/or dispersed therein. In another embodiment, the carrier consists essentially of water; optionally one or more additives to aid particulate dispersion, to provide pH maintenance, to modify interfacial tension (surfactants), and/or to act as anticoagulants; and a water-soluble dye.

Advantageously, the pH of the liquid carrier is between about 7 and about 9, for example between about 7.5 to about 8.5. The pH can be adjusted with sodium hydroxide, potassium hydroxide, alkaline earth oxides, methoxides, or hydroxides; or less preferably ammonium hydroxide. The pH of the injectable slurry is typically between pH 6 and 11, preferably between 7 and 10, for example between 7.5 and about 9.5.

In one embodiment the slurry comprises between 50 and 800 ppm of one or more scale precipitation inhibitors, particularly organophosphonates. Alternately or additionally, the slurry may contain between about 50 and about 2000 ppm of one or more chelators. Both of these additives are meant to inhibit precipitation of salts such as calcium carbonate and the like, where the source of calcium may be from the water used to make up the slurry. In one embodiment, the precipitation inhibitor comprises at least one and preferably at least two phosphonic groups. The precipitation inhibitor may comprise a phosphonic acid or salt of a phosphonic acid. The precipitation inhibitor may comprise at least one of a hydroxyethylidene diphosphonic acid and an aceto diphosphonic acid. A suitable phosphonate may be synthesized from phosphorous acid by reaction with formaldehyde and either ammonia or amines. A wood preservative of the invention may include at least one of a ethylenediamine tetra methylenephosphonic acid, a hexamethylenediamine tetra methylenephosphonic acid, a diethylenetriamine penta methylenephosphonic acid, and a 1-hydroxyethane diphosphonic acid. The preferred inhibitors are hydroxyethylidene diphosphonic acid (HEDP), diethylenetriamine-pentamethylenephosphonic acid (DTPMP), and/or 2-phosphonobutane-1,2,4-tricarboxylic acid (PBTC). If the preservative is in a slurry concentrate, the slurry should comprise between 10 mmoles and 100 mmoles/L of HEDP, or between 30 mmoles and 170 mmoles/L of PBTC or DTPMP. Mixtures of inhibitors are preferred, as concentrates may have more inhibitor than can readily be solubilized therein. If the preservative is in a solid form, the preservative should comprise between about 0.1 to about 1 mole HEDP per kg of particulates, or between about 0.17 to about 2 mole PBTC and/or DTPMP per kg of particulates.

To prevent biocidal particulates from agglomerating, the concentrated slurry may comprise emulsifiers such as gelatine, casein, gum arabic, lysalbinic acid, and starch; and/or polymers, such as polyvinyl alcohols, polyvinyl pyrrolidones, polyalkylene glycols and polyacrylates, for example, in quantities of about 0.01% to about 1% by weight, based on the weight of the biocidal particulates.

Manufacturing the Slurry: Wet Milling

Generally, the simple, inexpensive sparingly soluble salt precipitation processes provide particles with a size too great for injection. Even for processes that provide very small median diameter particles, e.g., a few tenths of a micron in diameter, the precipitation process seems to result in a small fraction of particles that are larger than about 1 micron, and these particles plug up pores and prevent acceptable injectability. The size distribution of the injectable particles must have the vast majority of particles, for example at least about 95% by weight, preferably at least about 99% by weight, more preferably at least about 99.5% by weight, be of an average diameter less than about 1 micron, and advantageously the particles are not rod-shaped with a single long dimension. Average particle diameter is beneficially determined by Stokes Law settling velocities of particles in a fluid to a size down to about 0.2 microns. Smaller sizes are beneficially determined by, for example, a dynamic light scattering method or laser scattering method or electron microscopy. Generally, such a particle size and particle size distribution can be achieved by mechanical attrition of particles.

At least partial attrition can be obtained, for example, by use of 1) a pressure homogenizer such as that manufactured by SMT Ltd. having about 400 kg/cm² of pressure at a flow rate of about 1 L/min., although such a system often requires the slurry to be processed overnight; an ultrasonic homogenizer, such as is manufactured by Nissei Ltd., although such a system is energy intensive; 2) by wet milling in a sand grinder or wet-ball mill charged with, for example, partially stabilized zirconia beads with diameter 0.5 mm; 3) alternately wet milling in a rotary sand grinder with partially stabilized zirconia beads with diameter of about 0.5 mm and with stirring at for example about 1000 rpm; a 4) an attritor (e.g., manufactured by Mitsui Mining Ltd.), or 5) a perl mill (e.g., manufactured by Ashizawa Ltd.,), or the like. Attrition can be achieved to a lesser degree by centrifugation, but larger particles can be simply removed from the composition via centrifugation to provide a injectable formulation. If necessary, particles may be used after adjusting the particle size to the desired value by separating coarse particles through a step such as wet type gravity sedimentation, centrifugation, filtering or the like. While this process provides injectable slurries, a fraction of the metal-containing particulates that are separated thereby include both large particles as well as a portion of the injectable particles, and generally this material would be recycled by being dissolved and precipitated. Such a process adds an additional cost to forming the injectable metal-containing particulate wood treatment.

Generally, there are two economical methods by which finely ground materials that make up the injectable biocidal particles may be produced. A first (less preferred method) is by contacting the biocidal particles with a very fast blade mill (a high speed blade miller very much like an Osterizer™ type mixer) run at very high RPMs. It is believed that unless there is very friable material or a large amount of material that can act as milling aids, that this first method will not be able to provide injectable particles within a narrow particle size range without additional processing, for example additional steps of separating and removing oversize particles by for example centrifugation. Additionally, such fast blade milling will not promote adherence of dispersants, other biocides, dyes, and pigments to the surface of biocidal particles, and in fact will continually strip such components from the surface of biocidal particulates. If particles are milled using a fast blade mill, then advantageously these particles are smoothed and large particles removed by for example ball milling or by continuous-process centrifuging to create a more uniform product.

The second and more preferred method of providing injectable biocidal particles is wet ball milling the biocidal material in a ball mill with a sufficient amount of surfactants and with a milling agent, wherein at least 25% (preferably at least 50%, more preferably 100%) of the milling agent comprises zirconia (or optionally zirconium silicate) having an average diameter of between about 0.02 and 0.08 cm, preferably between about 0.03 and about 0.07 cm. We have found that wet ball milling with appropriate milling media and dispersants can advantageously modify particle size and morphology to form readily injectable particles and slurries. Wet ball milling is believed to break up larger particles. Wet ball milling would also efficiently break particles having one large dimension, e.g., rod-like particles, which are know to have injection problems. Additionally, wet ball milling can be combined with a coating process to form a more stable material. The quickest and most efficient method of modifying the particle size distribution is wet ball milling. Beneficially, all injectable formulations for wood treatment should be wet-ball-milled, even when the “mean particle size” is well within the range considered to be “injectable” into wood. Traditional precipitation techniques are known to produce particles with a median particle size between about 0.2 and about 6 microns, depending on the salts used as well as on various reaction conditions. However, when this material is slurried and injected into wood, unacceptable plugging is postulated to occur on the face of the wood. Careful examination would find that prior art precipitation processes typically result in at least a few weight percent of particles with a size over 1 micron, and this small amount of material is hypothesized to form the start of the plug (where smaller, normally injectable particles are subsequently caught by the plug).

For example, biocidal material can be milled into an injectable material by wet ball milling with a milling material such as zirconium silicate useful for many inorganic biocidal salts) or zirconia (preferred for organic biocides and for resilient inorganic biocides) milling material having a diameter of between about 0.2 and about 0.8 mm, preferably between about 0.3 and about 0.7 mm, for example a zirconium silicate or doped zirconia having a diameter between about 0.4 mm and 0.6 mm, in a matter of minutes, and almost always in a time frame of 30 minutes or less. On the other hand, wet milling with zirconium silicate media having a diameter of about 2 mm is believed to have no effect—wet milling for days likely results in only a marginal decrease in particle size, and the material would still not be injectable in commercial quantities.

We have surprisingly found that a wet ball milling process using about 0.5 mm high density zirconium silicate grinding media provides further efficient attrition, especially for the removal of particles greater than about 1 micron in the commercially available metal-based particulate product. The milling process usually takes on the order of minutes to achieve almost complete removal of particles greater than about 1 micron in size. This wet milling process is inexpensive, and all of the precipitate can be used in the injectable metal-containing particulate wood treatment. The selection of the milling agents is not critical, and can be zirconia, partially stabilized zirconia, zirconium silicate, and yttrium/zirconium oxide, for example, recognizing that the more dense materials give faster particle size attrition. The size of the milling material is believed to be important, even critical, to obtaining a commercially acceptable process. The milling agent material having a diameter of about 2 mm or greater are ineffective, while milling agent material having a diameter of about 0.5 mm is effective typically after about 15 minutes of milling. We believe the milling agent is advantageously of a diameter less than about 1 mm in diameter, for example between about 0.1 mm and about 1 mm, or alternately between about 0.3 mm and about 0.7 mm. In one embodiment, the particles are wet milled using a milling media (e.g., grinding media) comprising beads having a diameter between around 0.1 mm and around 0.8 mm and having a density greater than about 3 g/cc.

Blade milling provides too much shear which degrades dispersants, while ball milling of the biocidal material in the presence of water, dispersants, and the pigment and/or dyes is believed to promote pigment/dyes adherence to biocidal particulates. It is known that as crystals are broken or even stressed as would occur during impact with the sub-millimeter zirconium oxide or silicate milling medium, there is a temporary instability wherein a cation (and/or an anion) in the solution can replace a similarly charged ion on the surface of the crystal. Such a surface will more tenaciously bond available surfactants and/or available cations present in the milling composition (usually present as soluble molecules and/or ions). The total addition of cations from solution is less than a mono-layer of the cations from solution. However, the added metals may stabilize the crystal, for example if copper hydroxide is milled in the presence of ions of zinc and/or magnesium. Such a milling mechanism can be used to beneficially add between 0.1 and 200 parts per million by weight of a very powerful biocidal salt for example silver ions, to the crystals. Alternatively such milling is beneficially used to facilitate attachment of polar and/or ionic pigments, dispersants, and dyes to the surface of the milled particles.

Injection into Wood

The wood preservative compositions of this invention are injectable into wood and wood composites. While wood composites may have the wood preservative composition of this invention simply mixed with the wood particles before bonding (usually with a plastic or resin), preferably at least a portion of the wood preservative compositions of this invention are injected into the wood particulates, which are then dried prior to bonding. Exemplary wood products include oriented strand board, particle board, medium density fiberboard, plywood, laminated veneer lumber, laminated strand lumber, hardboard and the like.

Preferably, the wood or wood product comprises a homogenous distribution of metal-based particles of the invention. In one embodiment, the density (weight of particles per volume of wood) of the biocidal particles about two cm from an exterior surface of the wood, and preferably throughout the interior of the wood or wood product, is at least about 50%, for example at least about 60%, alternately at least about 70% or at least about 75%, of the density of the biocidal particles found in the wood about 0.5 cm from the surface. Density is best measured by taking a core plug or a cross section from wood (well away from the ends), separating the wood starting from an exterior surface into layers 0.5 cm thick, and then pulverizing and digesting the layers in boiling sulfuric acid for a time sufficient to solubilize all the biocide, and then analyzing the acid to determine the quantities of biocidal materials that were in each layer. Preferably, the density (weight of particles per volume of wood) of the biocidal particles about three cm from an exterior surface of the wood, and preferably throughout the interior of the wood or wood product, is at least about 50%, for example at least about 60%, alternately at least about 70% or at least about 75%, of the density of the biocidal particles found in the wood about 0.5 cm from the surface. The same criteria are advantageously met by pigment particles as well—the density (weight of particles per volume of wood) of the pigment particles about two cm (or preferably about 3 cm) from an exterior surface of the wood, and preferably throughout the interior of the wood or wood product, is at least about 50%, for example at least about 60%, alternately at least about 70% or at least about 75%, of the density of the pigment particles found in the wood about 0.5 cm from the surface.

A necessary requirement to obtaining an homogenous distribution is that the particulates in the slurry do not tend to plate out or be trapped by the wood matrix during injection, and that the particulates in the slurry do not agglomerate prior to or during injection. For example, assume a slurry initially comprises 20 grams biocidal particles per liter, and during injection into a 6 cm rod the wood matrix absorbs (or traps as agglomerations) 10 grams of biocidal particles per cm. Then, measured radially from the axis of the 6 cm in diameter rod, the wood within 1 cm of the axis will have no biocidal particles, the wood between 1 and 2 cm will have on average the desired amount of biocidal particles (though distribution of the particles within this ring will be a gradient rather than uniform), and the wood that is between 2 and 3 cm from the axis will have two times the desired amount of biocidal particles. For this reason, the dispersants should be of a type and in a quantity to substantially prevent wood from absorbing onto a wood matrix during injection and from forming agglomerations during injection. In practical terms, to meet the goal where the density (weight of particles per volume of wood) of the biocidal particles about two cm from an exterior surface of the wood is at least about 50% of the density of the biocidal particles found in the wood about 0.5 cm from the surface requires that the wood absorb or trap (during injection) less than 10% of the available biocidal particles from a slurry per 0.5 cm of wood the slurry passes through. For example, if a slurry initially has 30 grams of biocidal material but loses about 10% of this material per 0.5 cm of wood the slurry passes through, then after injection into a 4 cm diameter rod is complete the wood that is 0.5 cm from the surface will have about 1.2 times the average density of biocidal particles while wood 2 cm from the surface will have 0.6 to 0.7 times the average density of biocidal particles.

Wood or wood products comprising the wood preservative compositions in accordance with the present invention may be prepared by any subjecting the wood to any standard injection practice currently used for injecting soluble wood treatments into wood. A preferred injection procedure includes the following four steps:

1) At least partially drying the wood, for example drying to remove at least 30%, preferably at least 50%, of the total moisture that can be removed by air drying the wood in ambient conditions. Green wood comprises sufficient air volume that a sufficient amount of wood preservative can be injected, but a more concentrated slurry would be required as compared to injecting into (at least partially) dried wood.

2) Subject the wood to vacuum, e.g, to below about 0.5 atmospheres and the injecting the slurry, and/or subject the wood to pressurized carbon dioxide, e.g., above about 30 psig, then vent the wood to atmosphere and inject the slurry. When slurry is injected into wood, the air in the wood is compressed. If no vacuum and/or carbon dioxide exposure is used, then the air in the wood will be compressed to one tenth of its original volume which will typically be in the center of the wood, and the slurry will therefore not reach the center one tenth of the wood. Further, releasing pressure causes the air to expand and push a portion of the injected fluid out from the wood, and this fluid may contain biocidal particles and/or pigment particles. A vacuum of as low as one half an atmosphere will reduce the amount of wood the slurry will not penetrate from one tenth to one twentieth of the total wood volume, and on releasing the pressure much less of the injected fluid will be expelled by the expanding air. Injecting carbon dioxide into the wood and then venting this to atmospheric pressure prior to injection will cause a portion of the air in the wood to be replaced by carbon dioxide. Carbon•dioxide is so soluble in the slurry that it acts much like a vacuum, in that the carbon dioxide once dissolved in the water will not be compressed and will not keep slurry from being injected into wood.

3) Inject the injectable aqueous slurry into the wood by immersing the wood in the slurry and then exerting an injection pressure of from above atmospheric pressure to about 300 psi, typically between about 75 psi and 150 psi. Injection of particles into the wood or wood product from a flowable material comprising the particles may require marginally longer (10 to 50% longer) pressure treatments than would be required for liquids free of such particles. The pressure is then maintained for a period of time that can range from a few minutes to many hours, and then the pressure is released. The drier the wood is made in step 1 prior to injection and the more rigorous the vacuum and/or carbon dioxide exposure is in step 2, the less time is needed where pressure should be maintained. Time is important, because most commercial slurries will have some small amount of particle settling, and long holding times will allow a greater amount of the particles in slurry outside the wood to settle on and stain the exterior surface of the wood. If using 150 psi injection pressure on wood having less than half of the water originally in the green wood, and also being exposed to sufficient vacuum and/or carbon dioxide cycles to remove 90% of the air in the dried wood, then the pressure maintenance period can usually be reduced to between 2 and 15 minutes (depending on the thickness of the wood being treated).

4) At least partially dry the wood, to further fixate the injected particles into the wood matrix.

Foliar Uses

Biocidal compositions described in this application are also useful in other applications, particularly for foliar applications. Often, especially for sparingly soluble biocidal inorganic copper-, nickel-, tin-, and/or zinc-based salts and for substantially water-insoluble organic biocides, smaller particles provide a greater degree of biocidal protection, as well as increased tenacity, also known as “rainfastness.” One problem with small particles is the well-known problem of photolysis, where the efficacy of biocides is quickly compromised due to exposure of the small particles of biocide in the field to moisture and/or UV radiation. The presence of an effective amount of a pigment, for example a water resistant pigment or UV-absorbing pigment materials, in the form of preferably oil-soluble organic pigments but can also comprise very fine pigment particles, e.g., having a diameter smaller than the diameter of the biocidal particles, typically having a d₅₀ of less than one fourth the d₅₀ of the biocidal particles, can be disposed on the exterior of biocidal particles, thereby protecting organic biocides either within the biocidal particle (as a solid phase) or coated on the exterior surface of the biocidal particle, will protect the biocide from damaging effects of sunlight in foliar applications. Such a composition will be useful for wood preservative applications and in foliar applications.

### EXAMPLES

The following examples are merely indicative of the nature of the present invention, and should not be construed as limiting the scope of the invention, nor of the appended claims, in any manner.

### Comparative Example 1

The laboratory-sized vertical mill was provided by CB Mills, model# L-3-J. The mill has a 2 liter capacity and is jacketed for cooling. Unless otherwise specified, ambient water was cycled through the mill cooling jacket during operation. The internal dimensions are 3.9″ diameter by 9.1″ height. The mill uses a standard 3×3″ disk agitator (mild steel) on a stainless steel shaft, and it operates at 2,620 rpm. The media used in this COMPARATIVE Example was 0.4-0.5 mm zirconium silicate beads supplied by CB Mills. All particle size determinations were made with a Sedigraph™ 5100T manufactured by Micromeritics, which uses x-ray detection and bases calculations of size on Stokes' Law.

The original formulation contained 20.4% chlorothalonil (98% active), 5% Galoryl™ DT-120, 2% Morwet™ EFW dispersant, and 72.6% water by weight, and the concentrate had a pH of 8.0. The total batch weight was about 600 g. The results of a 7.5 hour grinding study are given in Table 1 below.

TABLE 1
Wet ball milling Chlorothalonil with 0.5 mm zirconium silicate

| | | |
|---|---|---|
| | | Particle Size |
| | | Data - Volume % With |
| Milling | d₅₀ | Diameter Greater Than |

| Time Mins. | μm | 10 μm | 5 μm | 2 μm | 1 μm |
|---|---|---|---|---|---|
| 0 | 4.9 | 10 | 48 | 95 | |
| 30 | 1.3 | 0 | 4 | 21 | 68 |
| 60 | 1.0 | 4 | 2 | 11 | 50 |
| 90 | 1.4 | 18 | 23 | 22 | 94 |
| 120 | 1.03 | 2 | 0 | 4 | |
| 150 | 1.12 | 0 | 2 | 6 | 58 |
| 180 | 1.07 | 2 | 2 | 7 | 53 |
| 270 | 1.09 | 2 | 0 | 8 | 54 |
| 450 | 1.15 | 12 | 8 | 21 | 56 |

The results show that chlorothalonil can be wet milled from a starting particle size of about 3-4 microns to a d₅₀ near (but above) 1 micron within about one hour, using a spherical ˜3.8 g/cm³ zirconium silicate media having an average particle size of about 0.4-0.5 mm. Further grinding had little effect, possibly slightly reducing the weight of particles over about 2 microns and thereby reducing the d₉₀ from about 2 microns at 60 minutes to slightly less than 2. Further reduction of particle size requires using a much denser milling media such as zirconia.

### Example 2

Similar conditions were used in the experiments described in Example 2 as were used in comparative experiment 1. In this Example, the preferred organic biocides Chlorothalonil and Tebuconazole were milled. The milling media comprised cerium-doped zirconium oxide beads or yttrium-doped zirconium oxide beads, having a particle diameter of 0.4-0.5 mm or 0.3 mm. The density of the doped zirconium oxides is >6.0 g/cm³, compared to the ˜3.8 g/cm³ density of zirconium silicate beads used in comparative example 1. Additionally, the biocidal efficacy of milled chlorothalonil was compared to the biocidal efficacy of un-milled Chlorothalonil.

### Example 2-A

A first formulation, containing 20.4% chlorothalonil, 5% Galoryl™ DT-120 brand naphthalene sulfonate formaldehyde condensation product, 2% Morwet™ EFW, 3% Pluronic™ F-108 block copolymer (dispersant), and 69.2% water by weight, at a pH of about 7.3, was wet ball milled in a CB Mills, model# L-3-J mill with 0.4-0.5 mm doped zirconia. The total batch weight was about 600 g. The results are shown in Table 2 below.

TABLE 2
Wet ball milling Chlorothalonil with 0.4-0.5 mm zirconia

| | | Particle Size Data - | | | | | |
|---|---|---|---|---|---|---|---|
| | | Volume % With | | | | | |
| Milling | d₅₀ | Diameter Greater Than | | | | | |
| Time Mins. | μm | 10 μm | 5 μm | 2 μm | 1 μm | 0.4 μm | <0.2 μm |
| 0 | 3.44 | 8 | 30 | 77 | 92 | — | — |
| 90 | 0.31 | 3 | 3 | 3 | 3 | 22 | — |
| 240 | 0.21 | 0 | 1 | 2 | 3 | 3 | 51 |

The above-described composition does not have a particle size distribution which will result in a commercially acceptable injectable wood composition, even after 240 minutes of milling. The composition can be further treated with for example a centrifugal finishing technique which effectively removes all particles with an effective diameter greater than 2 microns to form an injectable composition—a technique removing all particles greater than 2 microns will remove most particles with a size over 1 micron and a substantial fraction, typically 10% to 50%, of particles over about 0.7 microns. While this material removed by the centrifuge can be recycled into the wet ball mill, such a process is not particularly energy efficient. Alternately, adding a sufficient amount of submicron pigment particles to a composition comprising 1 part of a substantially insoluble organic biocide composition prior to wet ball milling, wherein a sufficient amount is usually greater than 0.1 parts, for example from about 0.2 parts to 50 parts, but typically 0.3 parts to 4 parts, of small diameter inorganic pigment particles (or organic pigments provided they are sufficiently hard) per part of organic biocidal material, and wherein submicron means for example pigment particles with an average diameter d₅₀ and also a d₉₈ less than 0.5 microns, will reduce the average particle size of the milled chlorothalonil, and should eliminate the fraction of chlorothalonil particles with a particle size above 1 micron.

For the higher density 0.4 to 0.5 mm zirconia milling media, a Chlorothalonil composition with a d₅₀ less than 1 micron and a d₉₅ less than 1 micron was obtainable in less than 90 minutes, and a composition with a d₅₀ less than 0.3 microns and a d₉₅ less than 0.4 microns was obtainable in 6 hours.

This was a surprising result. Many people have attempted to reduce the particle size of chlorothalonil for a variety of reasons, with very little success. First, prior art 3 to 5 micron chlorothalonil particles are phytotoxic to many beneficial plant species. Second, it had been hypothesized that smaller particles of chlorothalonil would allow treatment rates to be reduced, under the theory that the biocidal activity of chlorothalonil is limited to a small radius about a particle, and if a prior art particle is present, then there is excess chlorothalonil. Therefore, minimum loading concentrations would reflect the number of particles needed to obtain coverage of the area to be protected times the weight of the prior art particles, which invariably had a distribution where more than half of the weight of the chlorothalonil was found in particles having a diameter greater than 2 or 3 microns. Prior attempts to mill Chlorothalonil using other techniques and milling media reported in the literature have resulted in Chlorothalonil slurries with a d₅₀ of between 2 and 3.5 microns (though some sub-micron particles were produced, the prior attempts to mill Chlorothalonil always resulted in a product with so many particles above about 2 microns that the d₅₀ was well above about 2 microns). One brand of chlorothalonil, DACONIL WEATHERSTIK™, commercially available from Syngenta, is advertised at the web-site “www.syngenta.com.au/Start.aspx?PageID=10101&ProductID=786125&menuId=” (accessed in October 2004) to have a “Finely ground formulation with smaller particles than generic chlorothalonil” and that “DACONIL WEATHERSTIK is a finely ground formulation, with smaller particles than generic chlorothalonil, resulting in superior coverage versus its competitors.” A test of a commercially obtained sample of this Bravo Weatherstik™ (Lot#GBY410802, D.O.M.:09/04) that we analyzed using a Micromeritics Sedigraph 5100 (where the diameter is deduced by hydrodynamic settling) has a median particle size d₅₀ of about 3 microns with about 14% by weight having a size less than 1 micron. While this is indeed an improvement in the particle size compared to other commercially available brands, we now routinely produce 30% active slurries of milled chlorothalonil product having a d₉₉ of about 1 micron or less and having a d₅₀, d₇₅, and even a d₉₀ of smaller than about 0.2 microns.

The milled material obtained after 90 minutes of milling represents an increase in number of particles per unit of mass by a factor of more than about 30 over the starting material, but the milled material obtained after 240 minutes of milling represents an increase in number of particles per unit of mass by a factor of more than about 1000 over the starting material. The higher surface areas associated with the smaller particles should give rise to a product with enhanced bioactivity due to an increase in reservoir activity (ability to deliver chlorothalonil to the infection court). Additionally, such a slurry is injectable into wood.

### Example 2-B

The next test was performed with a composition containing 20.8% tebuconazole, 3% Pluronic™ P-104 brand block copolymer, 1.5% Morwet™ D-425 brand naphthalene sulfonate, 0.1% Drewplus™ L-768 brand dimethylpolysiloxane (30%), and 74.6% water by weight. This composition was wet ball milled in a CB Mills Vertical Mill Model L-1 with 0.3 mm yttrium-doped zirconia. Prior to milling, the d₅₀ of the tebuconazole was about 27 microns. The results are shown in Table 3 below.

TABLE 3
Wet ball milling Tebuconazole with 0.3 mm zirconia

| Milling | Particle Size Data - Volume | | | | | |
|---|---|---|---|---|---|---|
| Time | % With Diameter | | | | | |
| Mins. | >50 μm | 25-50 μm | 10-25 μm | 1-10 μm | 0.2-1 μm | <0.2 μm |
| 0 | 26.6 | 27.2 | 42.2 | 4 | — | — |
| 150 | 0 | 0 | 3.6 | 4.2 | 20.7 | 71.5 |

The above-described composition does not have a particle size distribution which will result in a commercially acceptable injectable wood composition. The composition can be further treated with for example a centrifugal finishing technique which effectively removes all particles with an effective diameter greater than 2 microns to form an injectable composition—a technique removing all particles greater than 2 microns will remove most particles with a size over 1 micron and a substantial fraction, typically 10% to 50%, of particles over about 0.7 microns.

Alternately or additionally, we believe that adding to the milling composition one or more of inorganic biocidal particles and/or inorganic pigment particles, in an amount greater than about 1 part inorganic biocidal particles and/or inorganic pigment particles to 10 parts tebuconazole, will allow complete removal of tebuconazole particles greater than 1 micron. The mechanisms most likely are 1) the pigment particles and/or inorganic biocidal particles being imbedded into the milled tebuconazole such that subsequent interaction with the milling media will quickly split larger particles and therefore reduce or eliminate entirely the particles having a diameter greater than 1 micron after 150 minutes of milling time, and 2) pigment particles and/or inorganic biocidal particles will abrade the tebuconazole particles, causing further particle size reduction as the pigment particles and/or inorganic biocidal particles acquire a coating of the softer organic biocidal material.

### Example 2-C

The next test was performed with a composition containing 20.8% chlorothalonil, 3% Pluronic™ F-108 brand block copolymer, 1.5% Galoryl™ DT-120 brand naphthalene sulfonate formaldehyde condensation product, 0.1% Drewplus™ L-768 brand dimethylpolysiloxane (30%), and 74.6% water by weight. This composition was wet ball milled in a CB Mills Red Head™ Vertical Mill Model L-J-3 with 0.5 mm cerium-doped zirconia Prior to milling, the d₅₀ of the chlorothalonil was about 4.9 microns. The results are shown in Table 4 below.

TABLE 4
Wet ball milling Chlorothalonil with 0.5 mm zirconia

| Milling | Particle Size Data - | | | | | |
|---|---|---|---|---|---|---|
| Time | Volume % With Diameter | | | | | |
| Mins. | >25 μm | 10-25 μm | 5-10 μm | 1-5 μm | 0.2-1 μm | <0.2 μm |
| 0 | 3.8 | 7.8 | 38.3 | 51.5 | — | — |
| 250 | 0 | 0 | 1.5 | 1.5 | 48.2 | 48.8 |

The above-described composition does not have a particle size distribution which will result in a commercially acceptable injectable wood composition. However, subsequent tests with minor changes in the amount of surfactant allowed us to mill slurries so that less than 1% by weight of particles had a diameter greater than 1 micron, and the d₅₀ was 0.2 microns in one set of samples, while the d₉₀ was under 0.2 microns in a second set of examples. The composition can be further treated with for example a centrifugal finishing technique which effectively removes all particles with an effective diameter greater than 2 microns to form an injectable composition—a technique removing all particles greater than 2 microns will remove most particles with a size over 1 micron and a substantial fraction, typically 10% to 50%, of particles over about 0.7 microns.

We believe that adding to the milling composition one or more of inorganic biocidal particles and/or inorganic pigment particles, in an amount greater than about 1 part inorganic biocidal particles and/or inorganic pigment particles to 10 parts chlorothalonil, will allow complete removal of tebuconazole particles greater than 1 micron. The mechanisms most likely are 1) the pigment particles and/or inorganic biocidal particles being imbedded into the milled tebuconazole such that subsequent interaction with the milling media will quickly split larger particles and therefore reduce or eliminate entirely the particles having a diameter greater than 1 micron after 250 minutes of milling time, and 2) pigment particles and/or inorganic biocidal particles will abrade the tebuconazole particles, causing further particle size reduction as the pigment particles and/or inorganic biocidal particles acquire a coating of the softer organic biocidal material.

The above-described data shows how difficult it is to obtain the desired injectable particle size distribution when trying to mill tenacious organic biocides like TEB and chlorothalonil with a minimum of dispersants. The above experiments had between 0.2 parts and 0.5 parts total of dispersants, surfactants, wettability modifiers, and the like per part of organic biocide. Obtaining a smaller particle size becomes easier as more dispersants are added to the system. To go to an extreme, any milling technique using 1 part TEB with between 6 and 12 parts dispersants will “solubilize” the TEB and provide an injectable composition. There are two problems with that solution. First, the dispersants, surfactants, wettability modifiers, and the like are relatively expensive, and such a process is not cost effective. Second, we believe the presence of the large excesses of surfactants and dispersants promotes undesirable distribution and leaching characteristics for all components in the wood preservative composition. In preferred embodiments of this invention, there is less than 3 parts, preferably less than 2 parts, for example between about 0.1 parts and 1 part total of dispersants, surfactants, wettability modifiers, and the like per 1 part of organic biocide. The above experiments had between 0.2 parts and 0.5 parts total of dispersants, surfactants, wettability modifiers, and the like per part of organic biocide. Generally, if there was between 1 and 2 parts surfactant per 1 part organic biocide in the milling experiments described in Example 2, then above-described milling processes would be expected to provide the desired particle size distribution.

It is preferred that the amount of dispersants, surfactants, and the like be less than 2 parts, preferably between 0.1 and 1 parts, per part by weight of total organic and inorganic biocide. Alternately, if there is both solid phase organic biocide particles and/or solid phase inorganic sparingly soluble biocidal salt particles, but also pigment particles, in an alternate embodiment it is preferred that the amount of dispersants, surfactants, and the like be less than 2 parts, preferably between 0.1 and 1 parts, per part by weight of total organic and inorganic biocide and pigments. The desired particle size distribution can be obtained with that total amount of dispersants, surfactants, wettability modifiers, and the like, by aiding milling by adding sub-micron inorganic pigment material to the milling composition. Milling with the desired total amount of dispersants, surfactants, wettability modifiers, and the like, and further adding an amount of pigment, can provide the desired particle size distribution. The amount of pigment required will depend on a number of factors, but generally the total amount of pigment will be less than 3 parts, preferably less than 2 parts, for example between about 0.1 parts and 1 part total per 1 part of organic biocide. Alternately, adding sub-micron inorganic biocidal sparingly soluble salts or oxide material to the milling composition is expected to provide the desired particle size distribution. The amount of inorganic biocidal sparingly soluble salts or oxide material required will depend on a number of factors, but generally the total amount of inorganic biocidal sparingly soluble salts or oxide material will be less than 3 parts, preferably less than 2 parts, for example between about 0.1 parts and 1 part total per 1 part of organic biocide. Generally, as a milling aid, there is no difference between sparingly soluble inorganic biocidal salts, biocidal oxides, and pigments. Further, as described in subsequent Examples, the inorganic material need not be submicron particles prior to milling. The above-described milling process will quickly and efficiently form submicron slurries of the inorganic pigments, biocidal oxides, and/or sparingly soluble biocidal salts.

### Example 2-D

Biocidal Efficacy Tests: The principal advantage to obtaining smaller particles of substantially insoluble organic biocides and of particles of sparingly soluble biocidal salts and/or biocidal oxides is that the material can be injected into wood.

However, the same slurries can beneficially be used for any process or treatment currently calling for specific biocides, for example chlorothalonil which has extensive utility in treating a variety of foliar and other pathogens. For substantially insoluble organic biocides, we believe that until some particular submicron particle size is obtained, the biocidal particles act like point sources of the biocidal material, where dissolution and migration of biocidal material from the point sources is a major limiting factor on the biocidal efficacy of the treatment. For sparingly soluble inorganic salts, too small a particle size can result in a large portion of the biocidal metal being solubilized or otherwise flushed from wood. This is not as much of a problem with organic biocides, where obtaining particle diameters below 0.05 microns is very difficult and, even if such particles were formed, the solubility of the organic biocide is so low that we believe there will not be excessive premature flushing of organic biocide by water passing through treated wood. Generally, the problem with substantially insoluble organic biocides such as TEB and chlorothalonil is that the biocidal efficacy falls off sharply with distance from the particle. Therefore, an additional advantage of the small size and more importantly the narrow size distribution of the biocidal solid phase organic biocide particulates is that the small size allows there to be a close spacing of particles for a given biocidal loading. This advantage is useful both in wood treatment applications and in foliar and other applications.

One factor limiting particle size is the ability to economically obtain very small particles. The current disclosed invention resolves some of that problem. Other problems that can spring up when particle size is drastically reduced are: premature aging and degradation of the biocide within the particle, especially due to action of sunlight; and rainfastness. Many pigments, including the iron oxide/phosphate/hydroxide pigments described herein, protect against UV light damage. We believe that incorporation of pigments and/or dyes around biocidal particles, originally invented to mask the color of the biocide when injected into wood, can equally protect foliar applications of milled organic biocides from aging due to the action of sunlight. If a biocide is coated about a pigment particle, or even about a biocidal particle or even an inert carrier particle that blocks UV light, then at least a portion of the biocide will be protected against degradation by sunlight. Further, the same dispersants used to suspend organic biocide and other particles in the slurries of this invention will, when allowed to dry, greatly increase the rainfastness while at the same time reduce the phytotoxicity of these same biocidal particles when used in foliar applications. The only change in a preferred slurry for use in foliar applications as opposed to wood preservation applications is that the slurries destined for foliar applications may additionally benefit by including surfactants such as polyacrylates or acrylate-xanthan gum combos to further enhance rainfastness and mitigate phytotoxicity.

To test the efficacy of smaller chlorothalonil particles in a controlled environment, we asked Dr. Howard F. Schwartz, Professor of Plant Pathology, Colorado State University, Fort Collins, Colo. to prepare a test sequence to test the bioactivity of chlorothalonil slurries in an agar against a known pathogen, Botrytis aclada (Botrytis Neck Rot pathogen of Onion). Use of chlorothalonil against this pathogen is well documented, and there is a specific recommended concentration “X” to treat this pathogen. The control was commercially available Chlorothalonil of about 3 micron particle diameter with what is believed to be an EO-PO block copolymer dispersant (Bravo 720™). The two experimental milled chlorothalonil biocides were Samples A and B. Sample A was milled so that the d₅₀ was 0.2 microns. Sample B was milled so that the d₉₀ was under 0.2 microns.

Milled and a control Chlorothalonil products were slurried and then were added to 1 Liter of ½ PDA (potato dextrose agar) after autoclaving and cooling, where the amount added was X, 0.667×, 0.333×, or 0.1×. The agar was then allowed to set in a circular plate, and the center 38 mm² core of the cylinder was inoculated with 14-day-old Botrytis aclada, and then the plates were incubated for 14 days at 22° C. Growth of the colony was measured each day for 6 days for statistical analysis. Growth was measured an additional 8 days to determine number of days before the colony reached the outer edge of the plate. There were 10 samples for each biocide at each rate, and results were averaged. The data is summarized in Table 5 below.

TABLE 5
Growth Rate Per Day of ^{Botrytis} Colony
after 6 days of Incubation on PDA

| | | Growth Rate | Days to |
|---|---|---|---|
| Chlorothalonil | Concentration | (mm²/d) | reach barrier |
| d₅₀ = 3μ, prior art | 1X | 220 | >14 |
| d₅₀ = 3μ, prior art | 0.67X | 295 | 10-13 |
| d₅₀ = 3μ, prior art | 0.33X | 231 | 10-13 |
| d₅₀ = 3μ, prior art | 0.1X | 416 | 10-13 |
| d₅₀ = 0.2μ | 1X | 39 | >14 |
| d₅₀ = 0.2μ | 0.67X | 117 | >14 |
| d₅₀ = 0.2μ | 0.33X | 151 | >14 |
| d₅₀ = 0.2μ | 0.1X | 236 | 10-13 |
| d₉₀ = 0.2μ | 1X | 58 | >14 |
| d₉₀ = 0.2μ | 0.67X | 41 | >14 |
| d₉₀ = 0.2μ | 0.33X | 152 | >14 |
| d₉₀ = 0.2μ | 0.1X | 287 | 10-13 |
| Control | 0 | 923 | 5 |

C.V. % 15.91
LSD (alpha 0.01) 32.00

The daily measurements for days 1-6 are provided in Table 6. Treatments 1 (d₅₀=3μ particles at 1× concentration), 5-7 (d₅₀=0.2μ at 1×, 0.67×, and 0.33× concentrations), and 9-11 (d₉₀=0.2μ at 1×, 0.67×, and 0.33× concentrations) restricted fungal growth and never allowed the fungus to reach the outer edge of the plate throughout the 14-day test period. Treatments 2-4 (d₅₀=3μ particles at 0.67×, 0.33×, and 0.1× concentration), 8 (d₅₀=0.2μ at concentration of 0.1×), and 12 (d₉₀=0.2μ at concentration of 0.1×) allowed the fungus to reach the outer edge of the plate between days 10 and 13. Total maximum growth of the control was 5539 mm². The milled products A and B were consistently more effective than the commercially available product, and there was a consistent response to the rate comparisons between the 3 products in this lab test.

TABLE 6
Area (mm²) of Botrytis Colony on PDA, Days 1-6,

| Treatments | | | Day 1 | | Day 2 | | Day 3 | | Day 4 | | Day 5 | | Day 6 | |
|---|---|---|---|---|---|---|---|---|---|---|---|---|---|---|
| 1 | d50 = 3μ | 1X | 46 | BC | 46 | DE | 92 | CD | 352 | CD | 755 | D | 1321 | D |
| 2 | d50 = 3μ | 0.67X | 44 | C | 44 | DE | 108 | C | 405 | C | 871 | C | 1773 | C |
| 3 | d50 = 3μ | 0.33X | 42 | C | 42 | E | 50 | E | 313 | D | 690 | D | 1384 | D |
| 4 | d50 = 3μ | 0.1X | 43 | C | 61 | B | 161 | B | 501 | B | 1093 | B | 2497 | B |
| 5 | d50 = 0.2μ | 1X | 46 | BC | 48 | DE | 89 | CD | 131 | FG | 181 | F | 235 | G |
| 6 | d50 = 0.2μ | 0.67X | 48 | ABC | 48 | DE | 48 | E | 149 | FG | 389 | E | 701 | F |
| 7 | d50 = 0.2μ | 0.33X | 43 | C | 43 | DE | 64 | DE | 218 | E | 497 | E | 906 | E |
| 8 | d50 = 0.2μ | 0.1X | 43 | C | 58 | BC | 104 | C | 310 | D | 683 | D | 1416 | D |
| 9 | d90 = 0.2μ | 1X | 46 | BC | 46 | DE | 47 | E | 100 | GH | 219 | F | 347 | G |
| 10 | d90 = 0.2μ | 0.67X | 51 | AB | 51 | CD | 51 | E | 66 | H | 151 | F | 247 | G |
| 11 | d90 = 0.2μ | 0.33X | 47 | ABC | 47 | DE | 49 | E | 178 | EF | 481 | E | 914 | E |
| 12 | d90 = 0.2μ | 0.1X | 43 | C | 51 | CD | 92 | CD | 322 | D | 747 | D | 1721 | C |
| 13 | Control | NA | 52 | A | 92 | A | 274 | A | 1317 | A | 3039 | A | 5539 | A |

| | | | | | | |
|---|---|---|---|---|---|---|
| Probability | <0.0001 | <0.0001 | <0.0001 | <0.0001 | <0.0001 | <0.0001 |
| C.V. % | 15.11 | 19.50 | 38.63 | 23.09 | 18.46 | 18.91 |
| LSD (alpha 0.01) | 5.72 | 8.39 | 30.08 | 64.07 | 114.63 | 192.01 |

The first experiment, using prior art 3 micron chlorothalonil at the recommended dosage, provided good control of the Botrytis. In every test, for any concentration of chlorothalonil, the milled submicron chlorothalonil provided superior control of the Botrytis than did the unmilled control. What was particularly exciting was that both of the milled submicron chlorothalonil samples at both 0.67× and at 0.33× concentrations provided significantly superior control of Botrytis than did the unmilled commercial product applied at the recommended dosage 1×. This suggests that the milled product can be effectively applied at a fraction of the (foliar) application rate, for example between one third and two thirds of the application rate recommended for foliar application of prior art slurries, with no loss of effectiveness. Further, the small size of the particles coupled with the protective effects provided by dispersants, pigments, and/or dyes can mitigate phytotoxicity of the chlorothalonil and also mitigate chlorothalonil degradation due to exposure to light.

### Comparative Example 3A

In this comparative example, two slurries of copper hydroxide were wet-milled using 2 mm zirconium silicate as the milling medium. The first slurry had a d₅₀ of about 2.5 microns. The second slurry, a commercially available magnesium stabilized form of copper hydroxide particulate material, Champ DP® available from available from Phibro-Tech., Inc., has particles with a d₅₀ of about 0.2 microns.

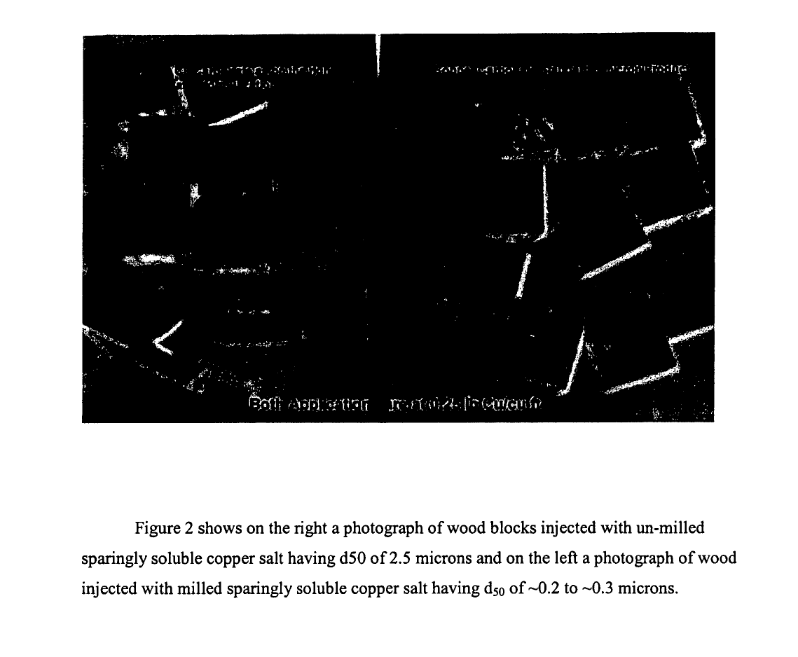

FIG. 2 shows the photographs that were obtain of trying to inject the untreated first slurry containing 2.5 micron d₅₀ copper hydroxide particles into wood. The copper material plugged the surface of the wood and made an unsightly blue-green stain, penetration of copper particles into the wood was very poor and uneven. Wood injectability tests revealed that while Champ DP® could be injected into wood without milling, the penetration was less than desired and there was still commercially unacceptable deposits of copper hydroxide on the exterior surface of the wood. Subsequent investigation revealed that while the d₅₀ of the material was <0.2 microns, about 13% by weight of the material had diameters between 0.4 and 1.5 microns, and 1% by weight had a diameter of about 2 microns or higher. In terms of numbers of particles, there were thousands to millions of particles with a diameter less than 0.4 microns for every particle with a diameter greater than 1 micron, but we believe that only a few large particles can form a bridge across a pore in the wood, and then a filter cake quickly forms as the bridge filters out smaller particles, and very quickly will not let any particles through regardless of particle size.

The Champ DP® material was placed in a mill with about a 50% by volume loading of 2 mm zirconium silicate milling beads. Samples were removed intermittently and the particle size distribution was determined. Wet milling with 2 mm zirconium silicate milling media had no substantial effect—wet milling for hours gave only a very slight decrease in particle size, and a small shift in the particle size distribution, but the material was not injectable into wood. Milling for a day or more did not provide a slurry with the desired particle size distribution.

### COMPARATIVE EXAMPLE 3B

Copper hydroxide (CHAMP FLOWABLE™, available from Phibro-Tech, Inc.) was wet ball milled with glass media having an average particle size of 0.7 to 0.9 mm. The copper hydroxide was very resistant to attrition using this milling media.

The milling media was then changed to 0.6-1.0 mm zirconium silicate. The CHAMP FLOWABLE™ material has a small initial d₅₀ of about 0.25, and while extended milling could give a particle size reduction to eventually provide a d₅₀ near 0.2 microns, there remained an excess of material over 1 micron in diameter. The mill was a KDL Pilot Unit available from CB Mills, run at 1200 RPM with a 0.3 micron gap spacing, 1120 ml of 0.6-1.0 mm zirconium silicate, with 700 ml of process fluid, a residence time of 1.5 to 14 minutes with recycle. Adding Rhodopol™ 23 to the slurry had some effect, but viscosity breakdown suggested dispersant breakdown. After 20 minutes of milling, there was still 15-20% by weight of particles having an average diameter greater than 1 micron. After 30 minutes of milling, there was still 10-15% by weight of particles having an average diameter greater than 1 micron. After 60 minutes of milling, there was still about 10% by weight of particles having an average diameter greater than 1 micron. The reduction in the amount of material having an effective diameter greater than 1 micron was not fast enough to provide a commercially useful injectable slurry.

### Comparative Example 3C

U.S. Pat. No. 6,306,202 suggests that particles containing copper salts or oxides can be injected into wood. The text states “small amounts of water insoluble fixed copper compounds are not objectionable in solid wood preservatives so long as their particle size is small enough to penetrate the wood,” and suggests “so long as copper compound particles do not settle from the dilution in one hour, the composition is suitable for pressure treating . . . of solid wood.” “Small amounts of water insoluble fixed copper compounds are not objectionable in solid wood preservatives so long as their particle size is small enough to penetrate the wood.” The patent does not suggest what size is useful. The patent teaches milling particles with a fast blade mixer for a time not to exceed one hour. Such a milling technique is limited in the lower size limit it can produce, and the particle size distribution resulting from such milling is broad. To duplicate the work done in this patent, we formed a mixture of 40 parts sodium tetraborate decahydrate, 54 parts tap water, and 8 parts copper hydroxide comprising dispersants and having a mean particle size of 2.5 microns (as measured by a Micromeritics Sedigraph 5100). This mixture was “milled” for 60 minutes using a laboratory dispersator (Indco Model HS-120T-A) operating at 3,000 rpm. The resultant mixture was then diluted at a ratio of 4 parts to 96 parts water (4%) for particle size measurement. After “milling” for 60 minutes, the d₅₀ was found to be 1.5 microns.

### Example 3

Copper hydroxide (CHAMP Formula II™, available from Phibro-Tech, Inc.) was wet ball milled with 0.6 to 1 mm zirconium silicate milling material. The mill was a KDL Pilot Unit available from CB Mills, run at 1200 RPM with a 0.3 micron gap spacing, 1120 ml of 0.6-1.0 mm zirconium silicate, with 700 ml of process fluid, a residence time of 3.3 to 30 minutes with recycle. Though the original CHAMP Formula II™ material had 15% of the material having a particle size of 1 micron or greater, as the residence time increased particle size decreased until the d99 was at about 1 micron or less. There was also a significant reduction in the d₅₀, from about 0.28 microns before milling to about 0.2 microns after milling. Milling conditions had to be optimized to obtain a d99 of 1 micron, and at less than optimum conditions a d97 of 1 micron could be obtained. Further, the d99 was not able to be reduced below about 0.7 microns—there remained about 2% or more of material having a particle size above 0.7 microns.

This suggested a injectable material might be obtained with less restrictive milling parameters if a smaller 0.5 mm zirconium silicate milling media were used. While 0.5 mm zirconium silicate was not an effective milling media for Chlorothalonil, it was found to be an adequate milling media for the more friable sparingly soluble copper salts, as shown below.

Five samples of particulate copper salts made following standard procedures known in the art were milled according to the method of this invention. The first two samples were copper hydroxide—one with an initial particle size d₅₀ of about 0.2 microns (the material of comparative example A), and the second with an initial d₅₀ of 2.5 microns. A basic copper carbonate (BCC) salt was prepared and it had an initial d₅₀ of 3.4 microns. A tribasic copper sulfate salt was prepared and this material has a d₅₀ of 6.2 micron. Finally, a copper oxychloride (COc) sample was prepared and this material has an initial d₅₀ of 3.3 microns. Selected surface active agents were added to each slurry, and the initial slurries were each in turn loaded into a ball mill having 0.5 mm zirconium silicate (density 3.3-3.8 grams/cm³) at about 50% of mill volume, and milled at about 2600 rpm for about a half an hour. The particle size distribution of the milled material was then determined. The particle size distribution data is shown in Table 5. It can be seen that even with the relatively modest zirconium silicate milling media, injectable compositions were obtained in about 30 minutes milling time or less.

It can be seen that even the less effective milling media, ˜0.5 mm zirconium silicate, was useful for milling sparingly soluble copper salts to the sub-micron particle size distribution needed for treating wood, for incorporating into non-fouling paints and coatings, and for foliar treatments. Further, the rate of particle size attrition is so great that there is no need to use expensive precipitation techniques to provide a feedstock having a sub-micron d₅₀. The initial d₅₀ ranged from 0.2 microns to over 6 microns, but after 30 minutes or less of milling each of the above milled copper salts (milling about 15 to about 30 minutes) were injected into wood samples with no discernible plugging.

Milling tenacious organic biocides such as TEB and chlorothalonil with less than 0.5 parts dispersants per part of solid organic biocide provided slurry compositions with particle size distributions that we very close to those sizes with are preferred for injectable slurries. Adding, to a composition comprising one part organic biocide prior to wet ball milling the composition, at least about 0.1 parts, typically about 0.2 parts to about 50 parts, for example from about 0.3 parts to about 5 parts, by weight of a millable inorganic material, especially submicron inorganic material such as submicron particles comprising a solid phase of one or more of: 1) sparingly soluble inorganic biocidal salts including hydroxides such as copper hydroxide, 2) inorganic biocidal oxides including copper and/or zinc oxide, 3) inorganic pigments such as iron oxides or iron phosphates, or any combinations thereof, to a composition comprising the desired amounts of surfactants, e.g., between about 0.05 parts to about 3 parts, typically from about 0.1 parts to about 2 parts, and in one embodiment from about 0.3 parts to about 0.5 parts, total of dispersants, wettability modifiers, surfactants, and the like per 1 part of solid biocidal material, will modify the milling characteristics when milled for 4 hours of less with a zirconia-type milling media having an average diameter between about 0.2 mm to about 0.8 mm, preferably from about 0.3 mm to about 0.6 mm, will form a stable injectable slurry. Milling sparingly soluble inorganic biocidal salts having any starting size, for example having an initial d₅₀ between about 0.1 microns to about 50 microns, with the more preferred zirconium oxide milling beads will provide in well under an hour a composition having essentially no material with a diameter greater than 1 micron. This suggests that if inorganic biocidal material and/or inorganic pigments are to be added to organic biocides prior to wet ball milling the composition, the added inorganic material need not be submicron prior to milling with the organic biocide.

TABLE 1
Particle Size Distribution Before/After Milling (0.5 mm
Zirconium Silicate)

| Material | d₅₀ | %<10μ | %<1μ | %<0.4μ% | <0.2μ |
|---|---|---|---|---|---|
| Cu(OH)₂, before milling | ~0.2 | 99% | 84% | 64% | 57% |
| Cu(OH)₂, after milling | <0.2 | 99% | 97% | 95% | 85% |
| Cu(OH)₂, before milling | 2.5 | 99% | 9% | — | — |
| Cu(OH)₂, after milling | 0.3 | 99.7% | 95% | 22% | — |
| BCC*, before milling | 3.4 | 98% | 1.2% | — | — |
| BCC*, after milling | <0.2 | 99% | 97% | 97% | 87% |
| TBS*, before milling | 6.2 | 70% | 17% | — | — |
| TBS*, after milling | <0.2 | 99.5% | 96% | 91% | 55% |
| COc*, before milling | 3.3 | 98.5% | 3% | — | — |
| COc*, after milling | 0.38 | 99.4% | 94% | 63% | — |

Milling sparingly soluble inorganic biocidal salts with the more preferred zirconium oxide milling beads will provide a smaller d₅₀ and will further reduce the amount of material, if any, having a diameter greater than 1 micron. Particulate biocides have an advantage over dispersed or soluble biocides in that the material leaches more slowly from wood than would comparable amounts of soluble biocides, and also about the same or more slowly than comparable amounts of the same biocide applied to the same wood as an emulsion.

### Example 4

INJECTING MILLED COPPER SALT SLURRIES INTO WOOD: Slurries of the above milled sparingly soluble copper salts were successfully injected into standard 1″ cubes of Southern Yellow Pine wood. The injection procedures emulated standard conditions used in the industry.

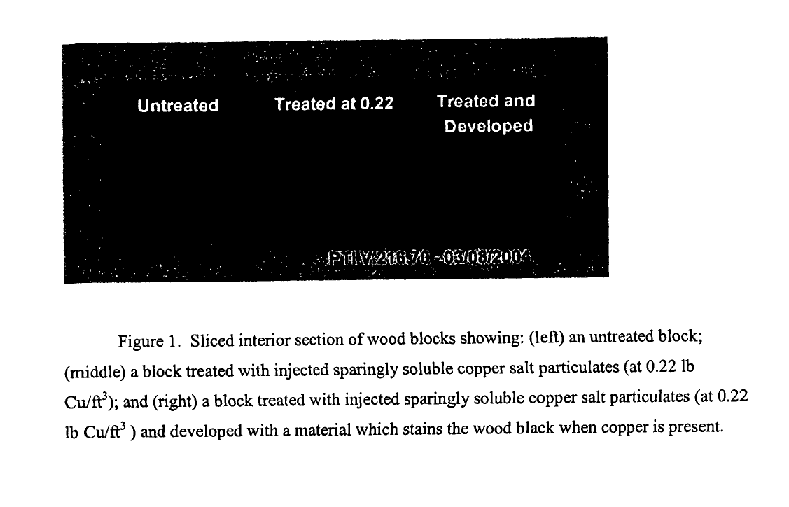

FIG. 2 shows representative photographs showing the comparison of the unacceptable product, which had a d₅₀ of 2.5 microns and completely plugged the wood, is shown in comparison with blocks injected with the product milled according to the process of this invention as described the Examples. FIGS. 1 and 2 show the clean appearance of the wood blocks injected with the milled copper hydroxide, to compare with the photograph in FIG. 2 of the wood samples injected with the un-milled (d₅₀<0.2 micron) copper hydroxide. Unlike the blocks injected with un-milled material, wood blocks injected with milled material showed little or no color or evidence of injection of copper-containing particulate salts.

Copper development by calorimetric agents (dithio-oxamide/ammonia) showed the copper to be fully penetrated across the block in the sapwood portion. FIG. 1 shows the penetration of injected particulate copper hydroxide developed with dithio-oxamide in the third picture. The stain corresponds to copper. It can be seen in FIG. 1 that the copper is evenly dispersed throughout the wood. Subsequent acid leaching and quantitative analysis of the copper from two blocks showed that loadings of about 95% and about 104% of expectation (or essentially 100% average of expectation) had occurred. At 100% loading, values of 0.22 lb/ft³ of copper would be obtained.

### Example 5

LEACHING COPPER FROM TREATED WOOD: Copper leaching rates from ¾ inch blocks of Southern pine, where slurries were prepared as described in Example 4, were measured following the AWPA Standard Method E11-97. In each case except the Cu-MEA-CO₃, the initial copper loading was a very high 0.25 lb Cu/cubic foot of wood, as opposed to a more traditional loading of for example 0.08 lb Cu/cubic foot of wood. For most examples, the organic biocide TEB was added to the slurry in an amount sufficient to provide 0.0075 lb TEB/cubic foot. One Example used a higher loading of 0.0125 lb TEB/cubic foot of wood. There are two comparative examples—leaching data was obtained from a wood block preserved with a prior art soluble solution of copper MEA carbonate, and also from a wood block preserved with prior art CCA. The leach rates of the various wood blocks treated with the preservatives prepared according to this invention were far below the leach rates of wood treated with soluble copper carbonate and were even below leach rates of samples treated with CCA.

Leaching data from wood was measured following the AWPA Standard Method E11-97 for the following preservative treatments, where, unless specified, the tebuconazole (TEB) concentration was 0.0075 lb TEB/cubic foot:

A) Basic copper carbonate (“BCC”) particulates with TEB;

B) CCA-treated wood (as a control);

C) Soluble copper methanolamine carbonate (“Cu-MEA-CO₃”) and TEB (as a control, believed to approximate the currently available Wolman E treatment);

D) BCC particulates with TEB and with sodium bicarbonate buffer,

E) BCC particulates;

F) Copper hydroxide, modified with zinc and magnesium, particulates (“Cu—Zn—Mg(OH)₂”) and TEB;

G) Copper hydroxide particulates modified with phosphate coating (“Cu(OH)₂—PO4”) and 0.0125 lb TEB/cubic foot;

H) Tribasic copper sulfate (“TBCS”) particulates and TEB; and

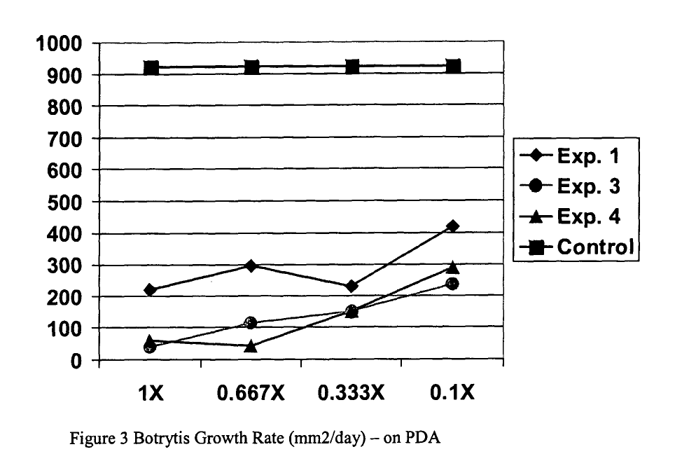

I) Copper oxychloride (“COC”) particulates and TEB. The leaching data from wood treated with each of the various particulate slurries and from two controls are shown in FIG. 3.

The total copper leached from wood preserved with a currently commercially dominant copper-MEA-carbonate/TEB system (at 0.08 lb Cu/cubic foot) was 4.6% at 6 hours, 8.1% at 24 hours, 9.8% at 48 hours, 13.6% at 96 hours, 14.8% at 144 hours, 15.3% at 192 hours, and 16% at 288 hours. In contrast, the total copper leached from wood preserved with prior art CCA was 0.3% at 6 hours, 1% at 24 hours, 1.7% at 48 hours, 2.5% at 96 hours, 3.3% at 144 hours, 3.8% at 192 hours, and 4.3% at 288 hours. This is illustrative of the problem the industry is facing. The amount of copper leached from the soluble copper-MEA-carbonate-treated wood was initially 15 times higher than the amount of copper leached from the CCA-treated wood, though by 288 hours this ratio had declined to about 3.7 times as much copper leached from the copper-MEA-carbonate-treated wood compared to the amount of copper leached from the CCA-treated wood. Generally, there is an initial biocide loss which shows the effects of biocide not being completely bound to the wood, but eventually the leach rates settle down to fairly constant numbers. Industry can not resolve the problem of high leach rates from soluble copper-amine treatments by simply adding more Cu-MEA-CO₃— we performed leaching tests on wood where the amount of Cu-MEA-CO₃ was more than 3 times the amount normally used, and in subsequent leaching tests we observed strikingly high leaching rates that eventually resulted in less copper being retained than is retained by wood treated with a more traditional dose. During the interval between 150 hours and 300 hours, the wood treated with soluble copper-MEA-carbonate was losing between about 0.2% of the total copper originally present per day. In contrast, the CCA-treated wood was losing about 0.17% of the total copper originally present per day. While this is not a large difference, the data suggests the CCA rate might be abnormally high due to some artificial interference, and also the high initial loss of copper coupled with the higher long term leach rate will result in significantly shorter life expectancy of wood treated with soluble copper-amines as opposed to the life expectancy of wood treated with the prior art CCA preservative.

Much less copper leached from the milled, biocidal particles, than leached from wood treated with the soluble copper amine preservatives. The amount of copper leached from wood treated with magnesium-stabilized copper hydroxide particulates with TEB was 0.2% at 6 hours, 0.3% at 24 hours, 0.4% at 48 hours, 0.5% at 96 hours, 0.6% at 144 hours, 0.7% at 192 hours, and 0.8% at 288 hours. The first surprising observation was there was substantially no early peak in the copper leach rate. At the 288 hour point in the leach test, wood treated with magnesium-stabilized copper hydroxide particulates with TEB had lost less than one fifth of the copper lost by wood treated with CCA, and only about one twentieth of the percentage of copper lost by wood treated with Cu-MEA-CO₃ and TEB. Second, during the interval between 150 hours and 300 hours, the wood treated with magnesium-stabilized copper hydroxide particulates with TEB was losing about 0.03% of the total copper originally present per day. We call the leach rate over that time period the “end-of-test copper leach rate”, and the end-of-test copper leach rate from wood treated by either CCA or Cu-MEA-CO₃ and TEB was about three times higher than the end-of-test copper leach rate from wood treated with the magnesium-stabilized copper hydroxide particulates with TEB.

The total leached copper at 144 and 288 hours and end-of-test copper leach rate for each of the treatments are given in Table 3 below.

TABLE 3
Copper Leached and Copper Leach Rates From Wood

| | | % Cu | % Cu | end-of-test |
|---|---|---|---|---|
| | | leached, | leached, | leach rate |
| | Preservative System | 144 hr | 288 hr | (% Cu/day) |
| A | BCC with TEB | 1.9 | 2.3 | 0.06 |
| B | CCA | 3.3 | 4.3 | 0.17 |
| C | Cu-MEA-CO3 with TEB | 14.8 | 16 | 0.20 |
| D | BCC with TEB, NaHCO₃ buffer | 1.7 | 2 | 0.05 |
| E | BCC | 2.3 | 2.8 | 0.08 |
| F | Cu—Zn—Mg(OH)₂ with TEB | 0.6 | 0.8 | 0.03 |
| G | Cu(OH)₂—PO4 with 0.0125 # | 3.1 | 3.8 | 0.11 |
| | TEB/cu ft. | | | |
| H | TBCS with TEB | 3.0 | 3.9 | 0.15 |
| I | COC with TEB | 4.1 | 5.2 | 0.18 |

One surprising result of this analysis was the suggestion that the end-of-test copper leach rate from wood treated with Cu-MEA-CO₃ was only 10% to 20% greater than the end-of-test copper leach rate exhibited by wood treated with copper oxychloride/TEB and by wood treated with CCA, and was only about 30-40% greater or with tribasic copper sulfate/TEB. However, the percentage of copper leached earlier in the leach test was many times higher for wood treated with Cu-MEA-CO₃ as compared to the copper leached from wood treated with any of the other preservatives.

A second surprising result was exhibited by the wood treated with phosphate-stabilized copper hydroxide—both the amount of copper leached and the long term leach rate were much higher than that of magnesium-stabilized copper hydroxide. It is hypothesized that 1) phosphate reacts during the milling process with compounds present in the milling slurry to either form a soluble copper compound; 2) milling dislodges and removes this very fine layer of copper phosphate from the biocidal particle to form a plurality of particles with a diameter less than 0.04 microns which can be flushed from wood; 3) the phosphate reacts with a component in the wood to increase copper solubility, or any combination thereof. In any case, phosphate-stabilized copper hydroxide has a much higher leach rate of copper than many other injected particulate salts, and has a long term copper leach rate and copper leached properties that are only marginally below those seen from wood treated with CCA.

Of the sparingly soluble salts used, the end-of-test leach rate, in descending order, is as follows:

Cu-MEA-CO₃ with TEB (0.20%/d), COC with TEB (0.18%/d)>

CCA (0.17%/d), TBCS with TEB (0.15%/d)>

Copper hydroxide with phosphate coating and TEB (0.11%/d)>

BCC (0.08%/d)>

BCC with TEB (0.06%/d), BCC with TEB and NaHCO₃ buffering (0.05%/d)>

Cu—Zn—Mg(OH)₂ with TEB (0.03%/d).

The relative leaching rates of the various salts suggests that the pH of the environment may be a factor. Its known that copper solubility in water increases by several orders of magnitude as the pH is lowered from about 7 to about 4. Wetted wood naturally has a pH of about 4.5 to 6, and metal hydroxide salts, e.g., copper hydroxide, are a preferred sparingly soluble biocidal salt because the hydroxide anions can increase the pH in wetted wood to near neutral. The ability of “basic copper salts” to raise the pH in wood varies greatly depending on the salt. The basic copper salts—basic copper carbonate, tribasic copper sulfate, copper oxychloride (basic copper chloride) can be viewed as being formed by admixing copper hydroxide and an acid and then crystallizing the salt: Basic copper carbonate is formed by adding one mole of a weak acid (carbonic acid) to two moles of copper hydroxide, and when dissolved in water will form a solution will have a basic pH; copper oxychloride is formed by adding one mole of a strong acid (hydrochloric acid) to two moles of copper hydroxide, and when dissolved in water will form a solution will have an acidic pH (pH˜5); and tribasic copper sulfate is formed by adding one mole sulfuric acid, which is a strong acid for the first proton and a weak acid for the second proton, to four moles of copper hydroxide, and when dissolved in water will as expected form a solution with a pH 6-6.5, which is between that from basic copper carbonate and from copper oxychloride. It was anticipated that leach rates of copper oxychloride would be greater than the leach rates for tribasic copper sulfate which would be greater than the leach rate for basic copper carbonate, which should be greater than the leach rate for copper hydroxide. This is consistent with the observed results.

While the alkaline characteristic of copper hydroxide makes copper hydroxide a preferred sparingly soluble copper salt, copper hydroxide is not without problems. The biggest problem with copper hydroxide is that it will readily dehydrate to form copper oxide. Copper oxide is much less biocidal than copper hydroxide, and copper oxide is less preferred than most any sparingly soluble copper salt. There are mechanisms to stabilize copper hydroxide against dehydration to copper oxide, and a preferred method is to replace between about 2 and about 20 mole % of the copper in copper hydroxide with zinc, magnesium, or both.

Basic copper carbonate is naturally resistant to loss of carbon dioxide and water, and is not readily converted to copper oxide. Also, basic copper carbonate has sufficient alkaline character to buffer the water in wood and promote a high pH which in turn retards copper leaching. For this reason basic copper carbonate is a very preferred sparingly soluble salt.

We note that “basic copper salts” are stoichiometric and the crystals therefore are homogenous, as opposed to for example a physical mixture of copper hydroxide and of copper carbonate where the relative amounts of each can be varied to any ratio. However, we expect similar results will be obtained from mixtures of finely divided copper hydroxide and other copper salts, such as copper borate. Basic copper borate may not form an homogenous stable crystal, because basic copper borate is not widely acknowledged. If basic copper borate does not exist, then a mixture of copper hydroxide (and/or basic copper carbonate) with copper borate at a mole ratio of about 1:1 to about 4:1, preferably at a ratio of about 2:1 to about 4:1, for example about 3:1, will provide a copper leach rate higher than that of copper hydroxide alone but lower than that of copper borate alone. Such a preservative system is preferred because it provides a relatively long-lived source of biocidal quantities of borate to the wood.

We also expect the copper leach rate to increase with decreasing particle size, but this effect was not apparent in the data. One possible reason is that there was only a factor of 2 in the d₅₀of the various sparingly soluble salts tested. However, leach rates from wood having a certain pound per cubic foot loading of copper salt is expected to be markedly lower for an injected slurry having a narrow particle size distribution around 0.2 to 0.4 microns as opposed to the leach rate from wood having the same pound per cubic foot loading of copper salt provided by an injected slurry having a narrow particle size distribution around 0.05 microns. The high leach rate of phosphate-stabilized milled copper hydroxide might be caused by dissolution and/or flushing of sub-0.050 micron particles from wood, but this is speculation.

There were several versions of the basic copper carbonate systems that were tested. A very surprising result was that the presence of only 1 part TEB per 60 parts basic copper carbonate (the amount in samples A and D) reduced leach copper from wood treated with basic copper carbonate particles by about 20%. The only explanation for the sharply reduced copper loss and also the reduced long term leach rate is that TEB is at least partially coating the exterior of the BCC particulates and is therefore inhibiting dissolution of the BCC. We know that dispersants also can coat the particles, but the TEB is very effective. If the TEB was assumed to be evenly spread across the outer surface of 0.20 micron particles, the layer of biocide would be between about 0.001 and 0.0015 microns thick. The reduction in total copper leached and in long term leach rates was very substantial for such a thin layer.

To test the hypothesis that pH had an effect, a buffering system comprising soluble sodium bicarbonate was added to a slurry of basic copper carbonate particles and TEB, which were then injected into the wood. The presence of the sodium bicarbonate reduced the amount of copper leached from the wood when compared to the amount leas, and might have reduced the end-of-test copper leach rate from wood, though the data is not statistically significant.

It can be seen from the above data and discussion that even a very small amount of substantially insoluble organic biocide, when wet ball milled with sub-millimeter zirconium-containing milling material, such as 0.3 mm to 0.6 mm zirconia, in a slurry comprising appropriate types and amounts of dispersants and also containing an inorganic material selected from: 1) one or more of a biocidal sparing soluble salts (which includes the metal hydroxide and also mixed salts, e.g., basic copper salts; 2) a biocidal metal oxide where the metal is selected from copper, zinc, and/or tin; 3) pigment particles, preferably inorganic pigment particles, or 4) and mixtures or combinations thereof, will result in the formation of a submicron slurry of particles having sparingly soluble inorganic biocide material in close association with particles of sparingly soluble salts, biocidal metal oxides, and/or pigments. If the substantially insoluble organic biocide is present in an amount less than about one tenth by weight of the particles of sparingly soluble salts, biocidal metal oxides, and/or pigments, it is likely that the organic biocide will at least partially exist as a layer disposed on the outer surface of the particles, where it will inhibit dissolution of sparingly soluble materials within the particle.

### Example 6

TOXICITY EVALUATION: A sample of treated wood was sent to an outside source for short-duration toxicity testing. The results suggest there is no difference in the Threshold Toxicity between wood treated with a copper MEA carbonate/tebuconazole formulation and wood treated with a identical loading of basic copper carbonate particles of this invention admixed (and partially coated with) the same quantity of tebuconazole.

### Example 7

Zinc Borate is a useful copper-free biocide with excellent anti-mold properties, and it also is useful at higher concentrations as a fire retardant in for example wood composites. A sample of zinc borate, Firebrake™ ZB commercially available from US Borax, was obtained. It is believed to be similar to or identical to the commercially available product Borogard™ ZB which is used as a preservative in wood composites. The d₅₀ of the commercial product was 7 microns. The product was wet ball milled as described herein, and the resulting slurry had approximately at least 80%, and in one case had 91%, by weight of the material having a particle size less than 0.2 microns. The data suggests that the slurries may have at least 80% by weight of the material having a particle size less than 0.1 microns. Slurries were successfully injected into wood. Additional testing is proceeding.

The invention is meant to be illustrated by these examples, but not limited to these examples. The invention includes the method of treating wood by injecting an effective amount of a biocidal slurry of this invention into wood. The invention includes the method of preventing or treating undesired bioorganisms on crops comprising the step of spraying an effective amount of a biocidal slurry onto crops. The invention includes the method of formulating a nonfouling paint or coating comprising incorporating into the paint or coating the an effective amount of a biocidal slurry of this invention into the paint or coating.

1. A wood-injectable particulate-based wood preservative comprising:
A) water as a carrier;
B) one or more dispersants in an amount sufficient to maintain biocidal particles in a stable slurry; and
C) injectable sub-micron biocidal particles comprising a solid phase of at least one of a substantially insoluble organic biocide, a sparingly soluble copper salt, copper(I)oxide, a sparingly soluble zinc salt, zinc oxide; a sparingly soluble nickel salt; and a sparingly soluble tin salt, wherein less than 2% by weight of the biocidal particles have an average diameter greater than 1 micron, and at least 20% by weight of the biocidal particles have an average diameter greater than 0.08 microns; and
D) at least one pigment particle or dye in an amount sufficient to impart a discernable color or hue to the wood, when compared to wood treated with the same particulate system but without the pigment.

2. The wood preservative of claim 1, wherein the wood preservative comprises particles containing at least 25% by weight of a solid phase comprising a substantially insoluble organic biocide selected from triazoles, chlorothalonil, iodo-propynyl butyl carbamate, copper-8-quinolate, fipronil, imidacloprid, bifenthrin, carbaryl, strobulurins, and indoxacarb.

3. The wood preservative of claim 1, wherein at least a portion of the biocidal particles comprise on the outer surface thereof at least 0.1% based on the weight of the particle of a substantially-insoluble organic biocide.

4. The wood preservative of claim 1, wherein the wood preservative comprises an oil soluble dye at least partially disposed on the surface of the biocidal particles.

5. The wood preservative of claim 1, wherein less than 1% by weight of the biocidal particles have an average diameter greater than 1 micron, and at least 40% by weight of the biocidal particles have an average diameter greater than 0.06 microns.

6. The wood preservative of claim 1, wherein the biocidal particles further comprise a leachability barrier disposed on the outer surface thereof that alters the leachability of the solid phase biocidal material of particles injected into wood by at least 10% when compared to the leachability of the solid phase biocidal material of injected particles not comprising said material disposed on the outer surface thereof.

7. The wood preservative of claim 1, wherein the biocidal particles further comprise an antioxidant and/or UV material disposed on the outer surface thereof that reduces the degradation rate of the solid phase biocidal material when compared to the degradation rate of the solid phase biocidal material of injected particles not comprising said material disposed on the outer surface thereof.

8. The wood preservative of claim 1, wherein the wood preservative further comprises an anticorrosive agent that reduces the tendency the treated wood to corrode metal.

9. The wood preservative of claim 1, wherein the biocidal particles further comprise organic dyes or inorganic pigments disposed on the outer surface thereof.

10. The wood preservative of claim 9, wherein the biocidal particles comprise particulate iron oxide pigments, zinc oxide pigments, magnesium oxide pigments, and/or tin oxide pigments which at least in part adhere to larger biocidal particles, and wherein the d₅₀ of the biocidal particles is between 50% to 1000% larger than the d₅₀ of the pigment particles.

11. The wood preservative of claim 1, wherein the pigment particles have a weight mean particle diameter d₅₀ below about 0.1 microns.

12. The wood preservative of claim 1, wherein the weight mean particle diameter d₅₀ of the pigment particles is between about 1 and 3 times the weight mean particle diameter d₅₀ of the injectable biocidal particles.

13. The wood preservative of claim 1, wherein the biocidal particulates have pigments and/or dyes associated with the surface thereof, the slurry injected in the wood can further comprise one or more water-soluble dyes in an amount sufficient to color the wood to a color distinguishable from untreated wood.

14. The wood preservative of claim 1, wherein the biocidal particles comprise a solid phase of a substantially insoluble organic biocide, and wherein the d₅₀ of the pigment is less than one fourth the d₅₀ of the of the biocidal particles.

15. The wood preservative of claim 1, wherein one or more dispersants are co-emulsified with the one or more pigments and/or dyes.

16. The wood preservative of claim 1, wherein the pigments comprise at least one of iron oxides, manganese oxides, or tin oxide, or the dyes comprise at least one of oil soluble wood dyes, alcohol soluble wood dyes, or Van Dyke brown.

17. The wood preservative of claim 1, wherein the pigments/dyes comprise at least one of azo, di-azo, polyazo, anthraquinone, thioindigo, pyrrolopyrrole, perylene, isoamidolin(on)e, flavanthrone, pyranthrone, isoviolanthrone phthalocyanine, quinacridone, dioxazine, or isoindoline series pigments/dyes, or naphthalenetetracarboxylic acid or perylenetetracarboxylic acid.

18. The wood preservative of claim 1, wherein the pigments comprise zinc sulfides, ultramarine, titanium dioxides, iron oxides, iron phosphates, antimony trioxide, nickel- or chromium-antimony-titanium dioxides, cobalt blue, manganese and manganous oxides, manganese borate, barium manganate, and chromium oxides.

19. The wood preservative of claim 1, wherein the pigments comprise basic compounds which can buffer water permeating through wood to a pH between 6 and 8.

20. The wood preservative of claim 1, wherein the d₅₀ of the pigment particles is within a factor of about 2 of the d₅₀ of the biocidal particles.

21. The wood preservative of claim 1, wherein the pigments comprise ferric phosphate and ferrous phosphate.

22. The wood preservative of claim 1, wherein the biocidal particles comprise an organic coating between about 0.01 and 0.1 microns thick comprising
a) a dispersing/anti-aggregation/wettability modifying agent,
b) an oil, wood rosin, rosin derivatives, waxes, fatty derivatives, or mixtures,
c) a substantially insoluble organic biocide; and
d) a dye or pigment associated with the organic layer.

23. A wood-injectable particulate-based wood preservative comprising: water; one or more dispersants in an amount sufficient to maintain biocidal particles in a stable slurry; injectable biocidal sub-micron biocidal particles comprising a solid phase of at least one of a substantially insoluble organic biocide, a sparingly soluble copper salt, copper(I)oxide, a sparingly soluble zinc salt, zinc oxide; a sparingly soluble nickel salt; and a sparingly soluble tin salt; and at least one pigment particle or dye in an amount sufficient to impart a discernable color or hue to the wood, when compared to wood treated with the same particulate system but without the pigment, wherein the pigment or dye forms a part of the injectable biocidal sub-micron biocidal particles.
